(19) United States
(12) Patent Application Publication
(10) Pub. No.: US 2001/0044734 A1
(43) Pub. Date: Nov. 22, 2001

(54) Method, system, and software for providing tax audit insurance

(75) Inventors: Daniel V. Walker, Santa Rosa, CA (US); Thomas Trude, Santa Rosa, CA (US); Michael D. Lopez, Santa Rosa, CA (US); Richard T. McNamar, Healdsburg, CA (US)

Correspondence Address: William T. Ellis, FOLEY & LARDNER, Washington Harbour, 3000 K Street, N.W., Suite 500, Washington, DC, 20007-5109, US

(73) Assignee: Audit Protection Insurance Services, Inc.

(21) Appl. No.: 09/814,096

(22) Filed: Mar. 22, 2001

Related U.S. Application Data
(60) Provisional application No. 60/229,298, filed on Sep. 1, 2000.

(51) Int. Cl. G06F 17/60

(52) U.S. Cl. 705/4

(57) ABSTRACT

A method, system, and software that provides insurance for costs resulting from an audit by a taxing authority, that includes accessing data relating to tax audit costs assessed by the taxing authority correlated to one or more parameters of taxpayers. Average tax audit costs are calculated for one or more groups of taxpayers using the data related to the tax audit costs such that each group is uniquely identified by at least one of the parameter for a taxpayer, and a premium rate to be charged is determined for each group of taxpayers based on the calculated average tax audit costs. The data relating to tax audit costs is obtained from information published by the taxing authority.

### CROSS-REFERENCE TO RELATED APPLICATIONS

This application claims the benefit of priority under 35 U.S.C. §119(e) of provisional application serial No. 60/229,298, entitled “Method and System for Providing Tax Audit Insurance” filed on Sep. 1, 2000, the disclosure which is incorporated herein in its entirety.

### BACKGROUND OF THE INVENTION

1. Field of the Invention

This invention relates generally to the field of methods, systems, and software for providing insurance. More particularly, the present invention relates a system and method for calculating the underwriting risk and premium, which are derived from calculations and past audit statistics, to be charged for providing audit protection insurance to taxpayers who file a particular type of tax return based on characteristics including, but not limited to, level and sources of income and deductions. The invention also includes the means of marketing the audit protection insurance, whether sold independently or as a bundled package with computerized tax preparation services. It includes the communications and processing systems for paying claims presented by policyholders.

2. Background of the Related Art

Millions of U.S. federal and state tax returns are filed periodically (typically annually). In addition, by law many millions more tax returns also must be filed in other international jurisdictions. Furthermore, various different categories of filers are required to file a tax return, such as individuals, small businesses, partnerships, and other corporate entities.

While the United States has a self-administered Federal and state tax system based on voluntary tax compliance, the Internal Revenue Service (the Federal tax administrator) and all U.S. states do systematic audits of the filed personal and business returns to ensure compliance with the tax laws, identify problems in the administration of the tax system, and to ensure that the highest number of the taxpayers are paying their required taxes. During an audit by a taxing authority, individuals and corporations (or other business entities) are required to produce detailed financial records. Furthermore, depending on the type of audit, they may be required to produce their detailed financial records and supporting documentation not only during the filing year in which the income tax return is filed but also three years following that for U.S. federal taxes. Other international taxing jurisdictions and state tax authorities in the U.S. have similar laws and audit practices.

During a tax audit, an individual may be required by the federal or state tax authority to produce each check and deposit slip for their checking account and justify the source and use of each individual item for the tax year audited. Regardless of the completeness of any individual taxpayer's record keeping, this is often an overwhelming task and an intimidating psychological experience. More often the taxpayers records are incomplete, misfiled, or partially lost through a relocation of home or business, further making the experience both emotionally disturbing and potentially financially expensive.

In general, the tax systems of the Internal Revenue System (“IRS”) and most states require that income be withheld at the source and paid periodically, such as, by wage withholding where the individual taxpayer receives a W- 2 at the end of the year showing the Federal, state, and local taxes withheld and paid. Additionally, periodic non-wage income, such as capital gains, may require a taxpayer to file a quarterly return. The rules on annual and quarterly filings, while very detailed, are often confusing to taxpayers who are not experts in this field and do not deal with these rules regularly. Further, the tax laws are generally changed each year. Sometimes the changes are small, but alter the previous year's filing requirements. In other years, the changes are quite substantive. In either event, the confusion and complexity to the tax filer in a self-administered system is enormous.

Accordingly, when the IRS determines in an audit that a taxpayer has not paid the required tax on an annual or quarterly basis, and provided the deficiency is minimal, the IRS treats the underpayment as a loan and assesses the unpaid balance plus interest. However, if the under-withholding of wages or the underpayment of annual or quarterly taxes is sufficiently large, then the audited taxpayer is assessed (a) the underpayment of the tax liability, (b) the interest from when the underpayment should have been paid, and (c) a penalty may or may not be assessed for non-compliance. The combination of additional tax liability, interest, and penalty may be a significant financial burden on many taxpayers who do not have the cash to pay this sum of money to the IRS or state tax authorities at the time of the audit. This is often an unexpected and significant financial burden to both individual taxpayers and small businesses.

Further, when the IRS audits a taxpayer and determines that the taxpayer has materially and intentionally underrepresented income or overstated their deductions, it will declare that the taxpayer has attempted to defraud or has defrauded the IRS. In this case, there are substantial monetary penalties. In the case of fraud, the IRS will automatically audit previous years filed but unaudited returns by the taxpayer. Normally, a determination of fraud will trigger an additional audit of at least the taxpayer's tax returns for the three previous years. Hence, the potential monetary tax liability to the taxpayer is multiples of the original tax underpayment. In extreme cases, criminal charges may also be filed. Most taxing authorities have similar laws and practices.

Many individuals and business owners, particularly small business owners, do not like to go through what they perceive as a complicated and confusing process of being audited with the uncertain financial exposure of a tax audit for the current or prior years.

However, assessing the risks related to a tax audit is a complicated process. For example, there are three types of audits used by the Internal Revenue Service. The first is a computer prepared letter that is sent to the tax filer. The second is an office audit by a tax auditor, where the filer is required to produce some or all of their records in the IRS office and justify some or all of the items on the filer's return. The third type of audit is a field audit by a revenue agent at the filer's home, or place of business in the case of a business return. State taxing authorities have similar grades of audit procedures and resulting investigations.

Even though there are established laws, regulations, and procedures for each of these audit processes and their state counterparts, most filers are unfamiliar with the procedures, their rights, and how to proceed when they are audited. In addition, despite great efforts in selection of auditors, and their training and supervision, the process is often unevenly administered and results in inconsistent administration of the tax system for similarly situated taxpayers in different parts of the country. This results in inequities for the taxpayer and adverse publicity for the IRS, which heightens taxpayer anxiety over the IRS audit process and its consequences to the taxpayer. For example, the imposition of negligence penalties varies widely by district for similar adjustments in taxpayer liabilities.

Many taxpayers seek professional representation from either a CPA, an attorney, or other professionally qualified tax preparer. While many taxpayers want to have professional representation, they are concerned about hiring one because of the cost and potentially open-ended liability they might incur for qualified professional representation.

Many taxpayers simply want to be certain that they will have adequate professional representation to handle even the minor inquires from the IRS, like the computer prepared letter, and that they can be certain that they will not have to pay additional taxes, interest on the additional assessed taxes, or a penalty. Both individual and small business taxpayers seek finality that once their taxes are filed, they will owe no more money, and that a qualified professional will handle all of the correspondence and meetings with the Internal Revenue Service or other taxing authority. In short, taxpayers seek to mitigate both their financial exposure and emotional anxiety from an audit through the purchase of audit protection insurance.

A number of professional tax preparation firms offer a warranty on their own preparation of the individual tax returns. Some of these warranties are limited warranties and others are reasonably full and include representation costs in case of a tax audit. If such firms prepare the tax return, these firms may represent the client during the audit process (up to specified cost limits) and pay any additional taxes, interest charges, and penalties on any error that can be attributed to the tax preparer himself.

In addition, a number of organizations offer prepaid representation services, but they do not offer protection against any additional taxes that may be assessed, interest on the underpayment of the taxes and potential penalties.

Therefore, there are no known prior art underwritten insurance products that, in the event of a tax audit, within policy limits, pays both costs (assessed taxes, interest, and penalties) of the Internal Revenue Service or state taxing authority audit and the costs of representation for individual and business tax returns, irrespective of who prepared the tax returns. Neither are there any computer based or Internet based tools that assess and quantify the risks and costs of a tax audit based on the certain parameters provided by the taxpayer.

The interrelationships of the distribution channels for tax audit insurance and the regulatory environment of the federal or provincial jurisdiction determine the distribution and sales management communications systems to be used in distributing the audit protection insurance policies. Within this regulatory framework, the present invention provides certain distribution channels that will be used both in the United States and in other countries.

### State Insurance Regulations

As a background on insurance regulations, which are legislated by the individual states in the U.S., there are two ways of obtaining legal permission from the state to write insurance. The most common way is to be an “admitted carrier” in all 50 states. This means that the company is licensed to write a type of insurance in the state, e.g. personal lines, property, or casualty insurance.

### Admitted Policy

In addition, an admitted carrier must file a particular policy that it intends to offer in the state with the state insurance commissioner (or other regulatory body) for their approval. The commissioner looks at the scope of the coverage, the legal terms of the policy itself, and the pricing of the policy to be sure that it is appropriately priced. Conversely, the commissioner wants to be sure that the policy will actually pay off the claims of those who buy it. Hence, the commissioner looks at the expected claims payout ratio of the policy (claims paid off/premium written in the state). Finally, the commissioner will recheck the financial strength of the admitted carrier to be sure they are likely to be able to pay the claims. For example, Allstate is an admitted carrier in all 50 states. When you buy an automobile property and casualty insurance policy from them, it has been approved by the insurance department in the state in which it is offered to the consumers.

### Non-Admitted Policy

There is a second widely accepted and legally established way to offer insurance in a state. This is by so-called “surplus lines carriers” who are not admitted to sell insurance in the state. This is usually commercial insurance sold to corporations in an insurance syndicate or reinsurance for an admitted carrier. Non admitted policies may also be used for individual sales, group insurance written for an affinity group, or as a voluntary association or employee benefit for corporate employees or association members. Lloyd's of London is a well known example of non-admitted carrier in many states. Lloyd's likely does not have a policy filed in a US state, such as Virginia, to sell homeowners insurance. However, if Lloyd's wanted to offer an esoteric type of homeowners insurance, for example, “insurance for theft from the household of particular items” and no admitted carrier were offering it, then Lloyd's could request the Virginia insurance authority to offer that policy using its surplus lines authority to write property casualty business. Assuming that there were no admitted carriers in Virginia currently offering it, Lloyd's would be routinely granted permission to write that particular insurance in Virginia on a surplus lines basis. A reason that insurance companies who are licensed to do so prefer to have admitted policies approved in the state is that multiple admitted policies, e.g. homeowners insurance may be approved by a state. Typically, the insurance authorities would prohibit sale of a non admitted policy if an admitted policy for the same coverage has been approved.

Therefore, it is a difficult, time consuming, and expensive process to sell tax insurance as an admitted carrier in all of the states.

### SUMMARY OF INVENTION

Therefore, it is a general objective of the invention to mitigate the taxpayers audit related problems and uncertainties and the tax insurance distribution difficulties identified above.

In one aspect, the present invention contemplates that tax insurance may be offered by establishing an association. For example, taxpayers will be offered the opportunity to join an association, such as an American Taxpayers Association (ATA). As an ATA member, the taxpayer will receive Basic Audit insurance coverage as a member benefit in their state. The American Taxpayers Association is chartered in a single state, for example, Nebraska. A master tax insurance policy is issued in Nebraska (for example) to the ATA for the benefit of all of its members, wherever they live. The ATA will issue membership statements to all members, including a certificate that indicates that the ATA has insurance that will reimburse them (up to the policy limit) if the IRS should audit them. All other states regard this as an association membership benefit, rather than selling insurance in that other state. This is a method of selling insurance on a surplus lines basis in one state and providing it as an association member benefit to members in other states. The present invention, for the first time, uses this method of distribution to sell tax audit protection insurance.

In one aspect, the present invention provides a computer implemented method of providing insurance for costs resulting from an audit by a taxing authority, including the steps of: accessing data relating to tax audit costs assessed by the taxing authority correlated to one or more parameters of taxpayers; calculating average tax audit costs for one or more groups of taxpayers using the data related to the tax audit costs, wherein each group is uniquely identified by parameter values for a taxpayer; and determining a premium rate to be charged for each group of taxpayers based on the calculated average tax audit costs.

In another aspect, the data relating to tax audit costs is obtained from information published by the taxing authority.

In a further aspect, the data relating to the tax audit costs is stored in a database system.

In another aspect, the data relating to tax audit costs is accessed from a third party source.

In one aspect, the present invention further includes: calculating average representation costs for defending a tax audit for taxpayers in each group; and adjusting the premium rates based on the calculated average representation costs.

In one aspect of the invention, the step of determining the premium rate includes accessing a claims database storing information regarding IRS audit practices and statistics, prior claims paid by the company, as well as third-party tax audit statistics.

In one aspect, the parameters include one or more of: the filing status of taxpayer, total income of taxpayer, type of tax return filed by taxpayer, types of deductions claimed by taxpayer.

In another aspect of the present invention, the tax audit costs may include, but are not limited to, additional assessed taxes, interest on the additional assessed taxes, and penalties.

In another aspect, the present invention includes a computer readable data storage medium having program code recorded thereon for providing insurance for costs assessed from a tax audit by a taxing authority, the program code including: a first program code that accesses data relating to tax audit costs assessed by the taxing authority correlated to one or more parameters of taxpayers; a second program code that calculates average tax audit costs for one or more groups of taxpayers using the data related to the tax audit costs wherein each group is uniquely identified by parameter values for a taxpayer; and a third program code that determines a premium rate to be charged for each group of taxpayers based on the calculated average tax audit costs.

One aspect of the present invention provides a computer-implemented method of interactively accessing and displaying the probability and costs associated with a tax audit by a taxing authority, the method including the steps of: receiving parameter values entered interactively by the taxpayer, accessing calculated tax audit statistics (derived from taxing authority statistics, third-party sources, and internally developed statistics) correlated to the filing characteristics subsets of taxpayers, and displaying the probability and average tax audit costs of the filing characteristics subset matching the parameter values provided by the taxpayer.

Another aspect of the present invention provides a system for providing insurance for the costs associated with a tax audit by a taxing authority. The system includes: a computing unit for accessing data relating to tax audit costs assessed by the taxing authority correlated to one or more parameters of taxpayers; a computing unit for calculating historical average tax audit costs for one or more discrete subsets of taxpayers using the data to calculate the tax audit costs wherein each group is uniquely identified by parameter values for a subset of taxpayers; and a computing unit for determining a premium rate to be charged for each subset of taxpayers based on the calculated average tax audit costs, where a change was made in the assessed tax liability.

A further aspect of the invention is an Internet based delivery of underwritten insurance against all assessed taxes, interest, and penalty and the costs of professional representation in the event of an IRS or state tax audit, regardless of the audit type.

Another aspect of the invention is to provide certainty to the insurance policy holder that unless fraud is discovered during the tax audit, there will be no additional out of pocket costs related to the tax audit up to the established policy limits. In the preferred embodiment of the invention, additional out of pocket costs above the policy limits will be paid by the policy holder. This co-pay feature may be a part of all of the alternative embodiments.

Another aspect of the invention is to offer insurance to mitigate the cost of a tax audit and representation regardless of who prepares the return; the taxpayer, a professional tax preparer, or a computer program used by the individual taxpayer to perform the calculations. While the cost of the insurance may vary with the preparer of the return and the complications of the return, it is available to both clients of third-party tax return preparers or the individual taxpayers who prepare their own return with or without a computer program.

Another aspect of the invention is to offer underwritten insurance where the underwriting company or its agent specifies the underwriting criteria, e.g. exclusions, pricing and the related premium to the coverage specified in the policy limit(s) for each subset of taxpayers.

A further aspect of the invention is to offer underwritten insurance to individuals through the Internet or to affiliated taxpayers as a group benefit. Another aspect of this invention is to offer insurance for various types of tax returns, including but not limited to, individual returns, Subchapter S returns, LLC returns, LLP returns, partnership returns, or C corporation returns whether through the Internet or to taxpayers affiliated as a group.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is a schematic diagram showing the components of a general purpose computer connected to an electronic network.

FIG. 2 is a schematic diagram illustrating the high level components of the tax insurance system of the present invention.

FIG. 2A displays the audit related statistics in Table 11 of the Data Book published annually by Internal Revenue Service.

FIG. 2B provides a Glossary of terms as a reference for later sections of the present application.

FIG. 2C, 2D and 2E comprise an exemplary worksheet which details the series of steps performed to calculate the Total Claim Exposure Per Policy Sold in one preferred embodiment of the present invention.

FIG. 2F is a category worksheet that displays all [Audit Rates] and [Average Additional Tax and Penalty] for all combinations of [Filing Characteristic Subsets], [Type of Audit Subset], and [Audit Result Subset]. It also displays the development of similar information for [Underwriting Categories] derived by combining [Filing Characteristic Subsets].

FIG. 3 is a high level dataflow diagram of the Product Development and Management component of the tax insurance system of the present invention.

FIG. 4 is a dataflow diagram that illustrates the ‘Calculate Risk Premium Amounts’ sub-component of the Product Development and Management component of the tax insurance system of the present invention.

FIG. 5 is a high level dataflow diagram of the Marketing Including Risk Evaluator component of the tax insurance system of the present invention.

FIG. 6A is a display of an exemplary first page of the Risk Evaluator Questionnaire.

FIG. 6B is a display of an exemplary second page of the Risk Evaluator Questionnaire.

FIG. 6C is an exemplary display of the response page of the Risk Evaluator which, in the present invention, provides customized information (Odds, Average Risk, Recommended Products, and Custom Paragraphs) relating to the taxpayer's tax filing profile.

FIG. 7A is a high-level dataflow diagram of the Distribution/Sales Management component of the tax insurance system of the present invention.

FIG. 7B is a dataflow diagram that illustrates the ‘Manage Referrals’, ‘Execute Risk Evaluator’ and ‘Tax Insurance Application’ sub-components of the Distribution/Sales Management component of the tax insurance system of the present invention.

FIG. 8 is a high-level dataflow diagram of the Issuance component of the tax insurance system of the present invention.

FIG. 9 is a high-level dataflow diagram of the Policy Administration component of the tax insurance system of the present invention.

FIG. 10 is a high-level dataflow diagram of the Claims component of the tax insurance system of the present invention.

FIG. 11 is a flowchart illustrating the exemplary process flow of the claims administration aspect of the present invention.

FIG. 12 illustrates the components and interactions of a group master policy distribution aspect of the present invention.

FIG. 13 is a flowchart illustrating the process flow of integrating the sales of the tax insurance product with an automated tax preparation service.

FIG. 14 is a flowchart illustrating the underwriting process for a group policy offering tax insurance according to the present invention.

### DESCRIPTION OF THE PREFERRED EMBODIMENT(S)

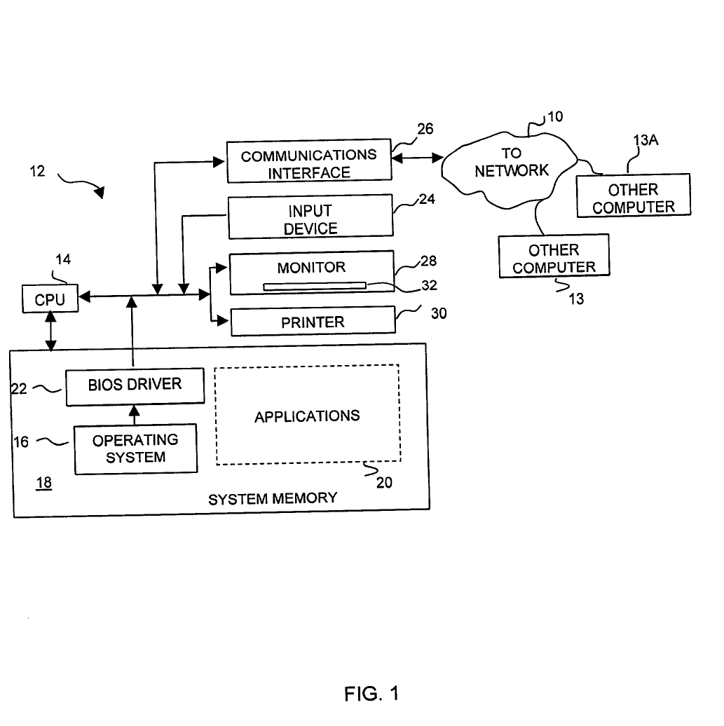

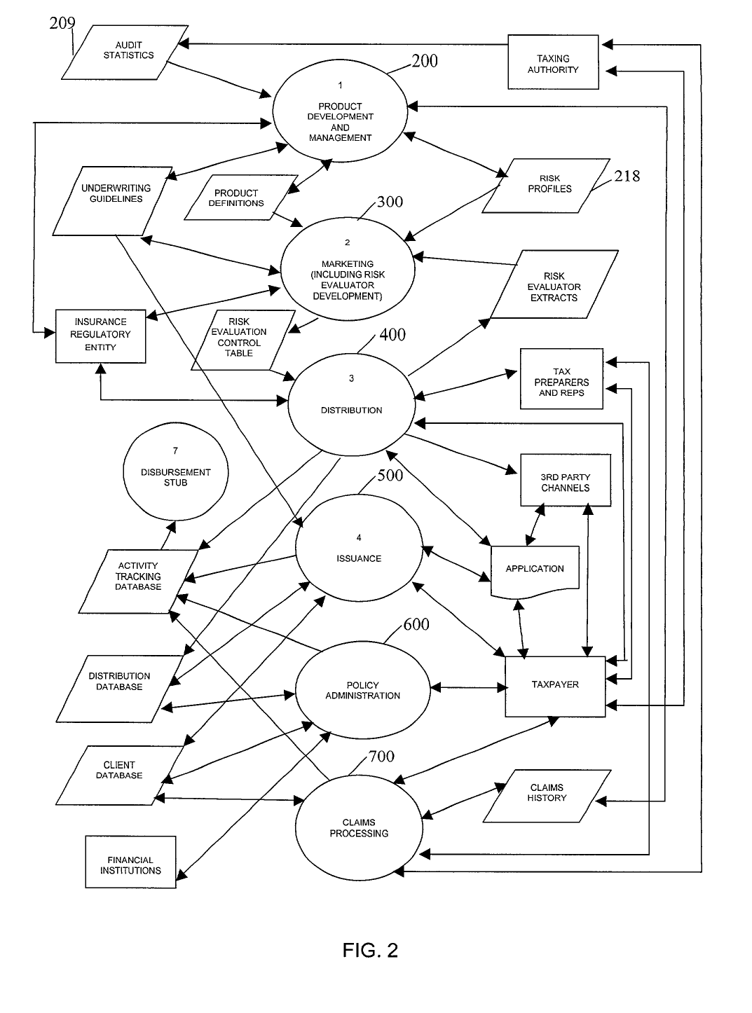

With reference to the Figures, FIG. 1 is a block diagram showing the components of a general purpose computer system 12 connected to an electronic network 10, such as a computer network. The computer network can also be a public network, such as the Internet, a private network or a virtual private network. As shown in FIG. 1, the computer system 12 includes a central processing unit (CPU) 14 connected to a system memory 18. The system memory 18 typically contains an operating system 16, a BIOS driver 22, and application programs 20. In addition, the computer system 12 contains input devices 24 such as a mouse and a keyboard 32, and output devices such as a printer 30 and a display monitor 28. The computer system generally includes a communications interface 26, such as an ethernet card, to communicate to the electronic network 10. Other computer systems 13 and 13A also connect to the electronic network 10 which can be implemented as Wide Area Network (WAN) or as an inter-network such as the Internet. One of skill in the art would recognize that the above system describes the typical components of a computer system connected to an electronic network. It should be appreciated that many other similar configurations are within the abilities of one skilled in the art and all of these configurations could be used with the methods of the present invention. Furthermore, it should be recognized that the computer system and network disclosed herein can be programmed and configured, by one skilled in the art, to implement the method steps discussed further herein.

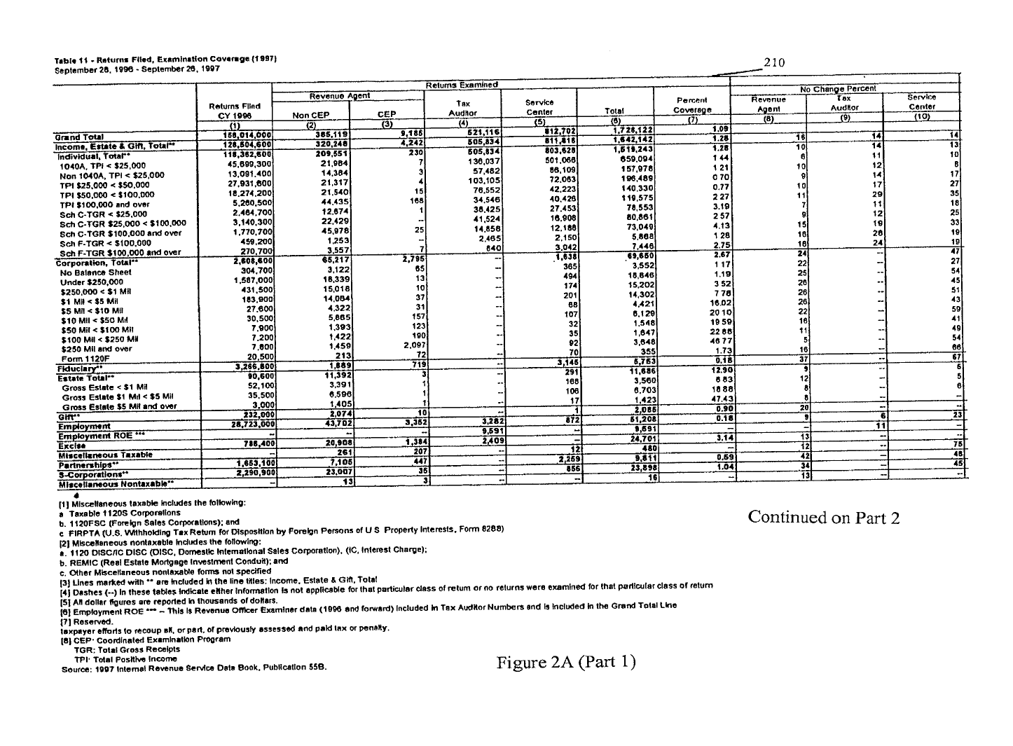

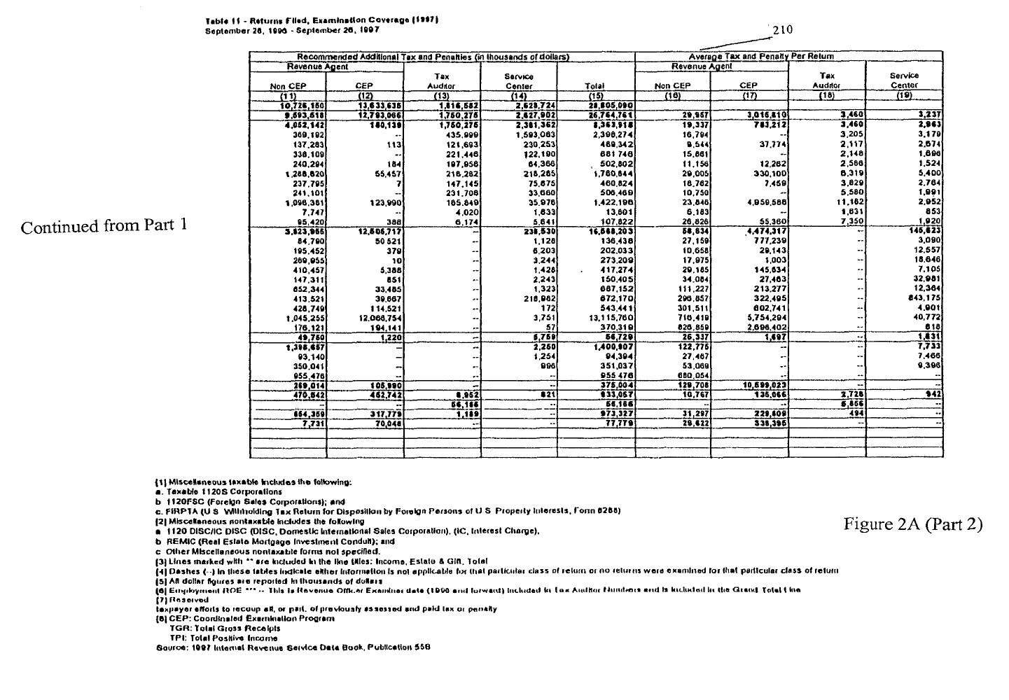

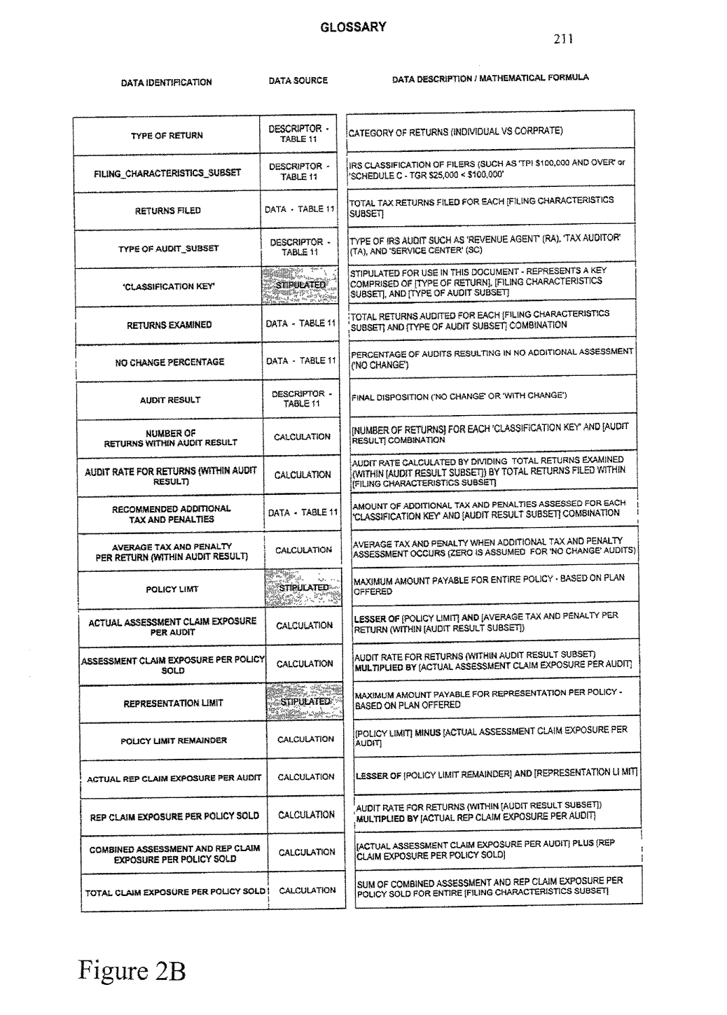

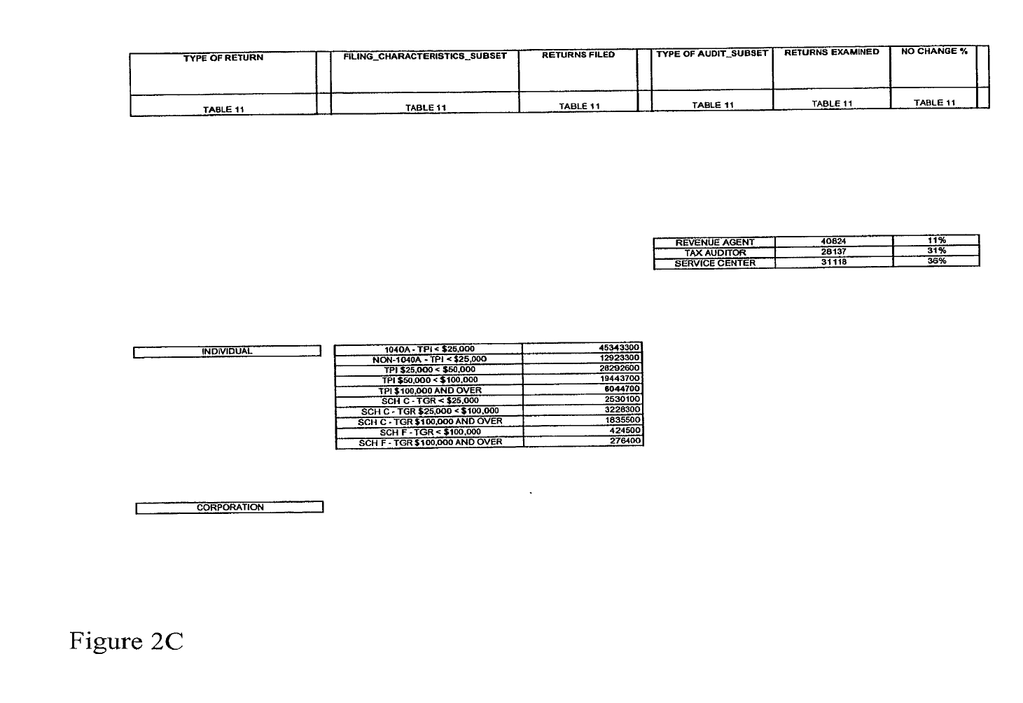

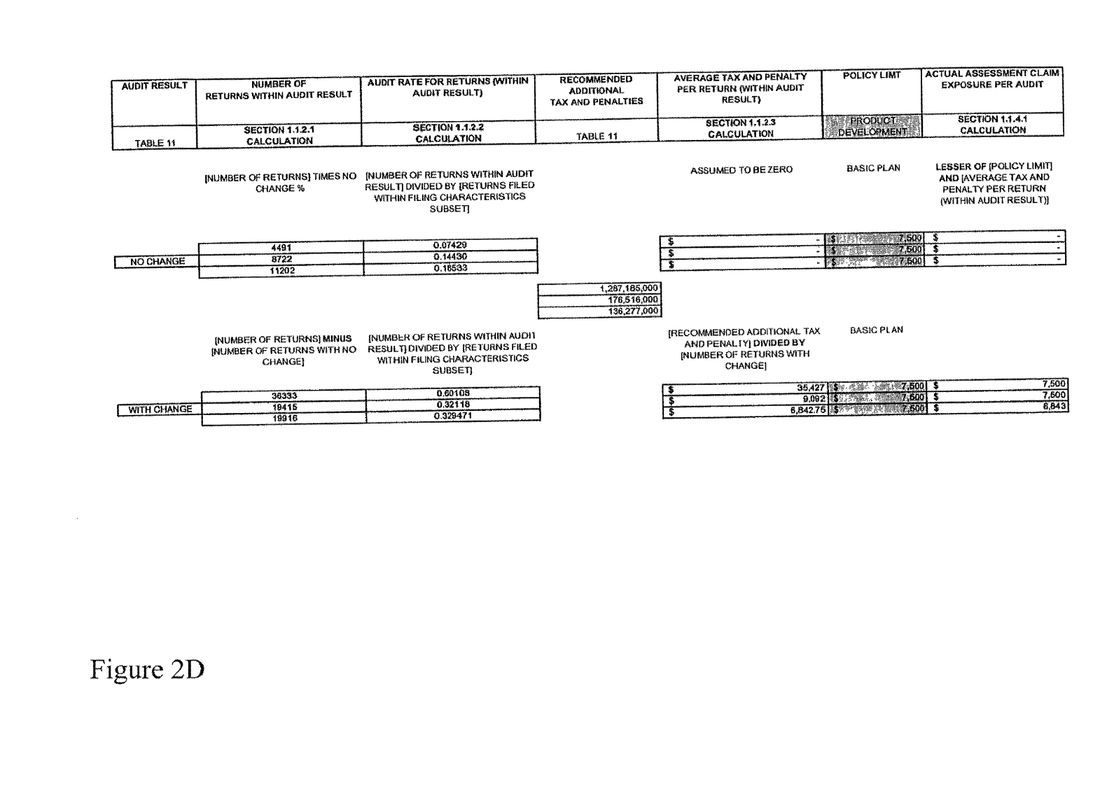

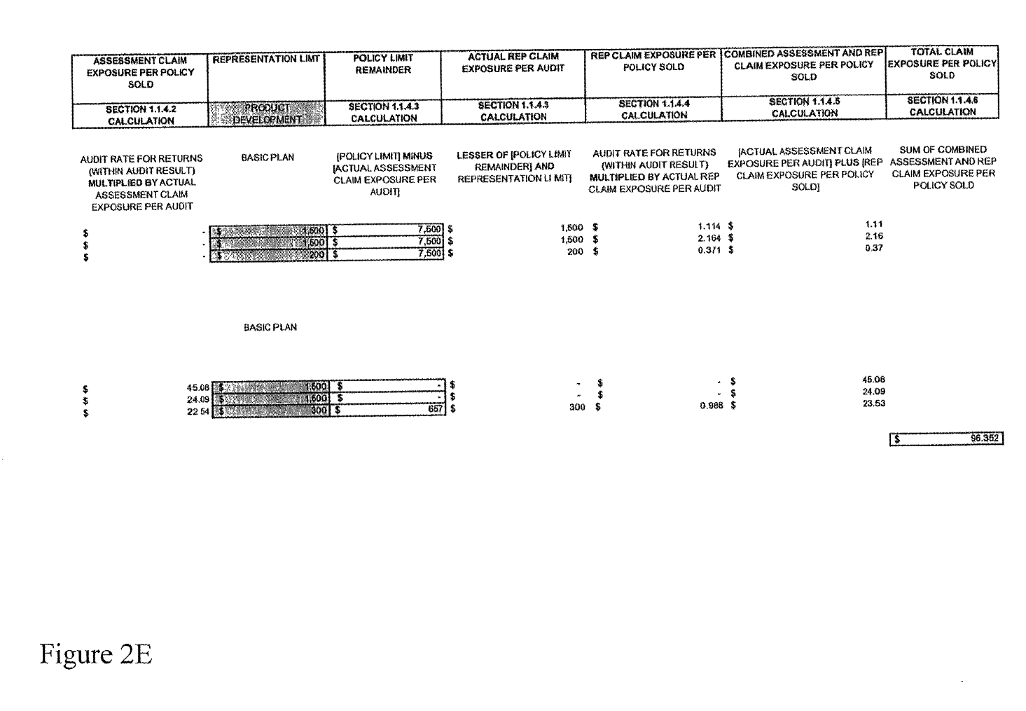

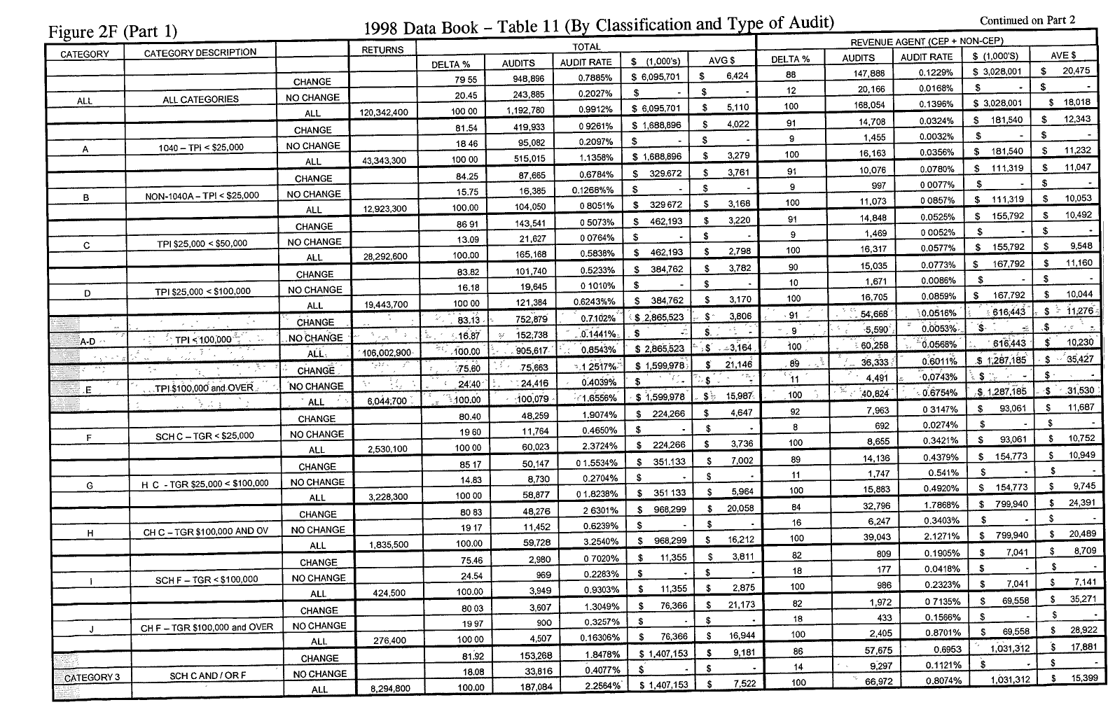

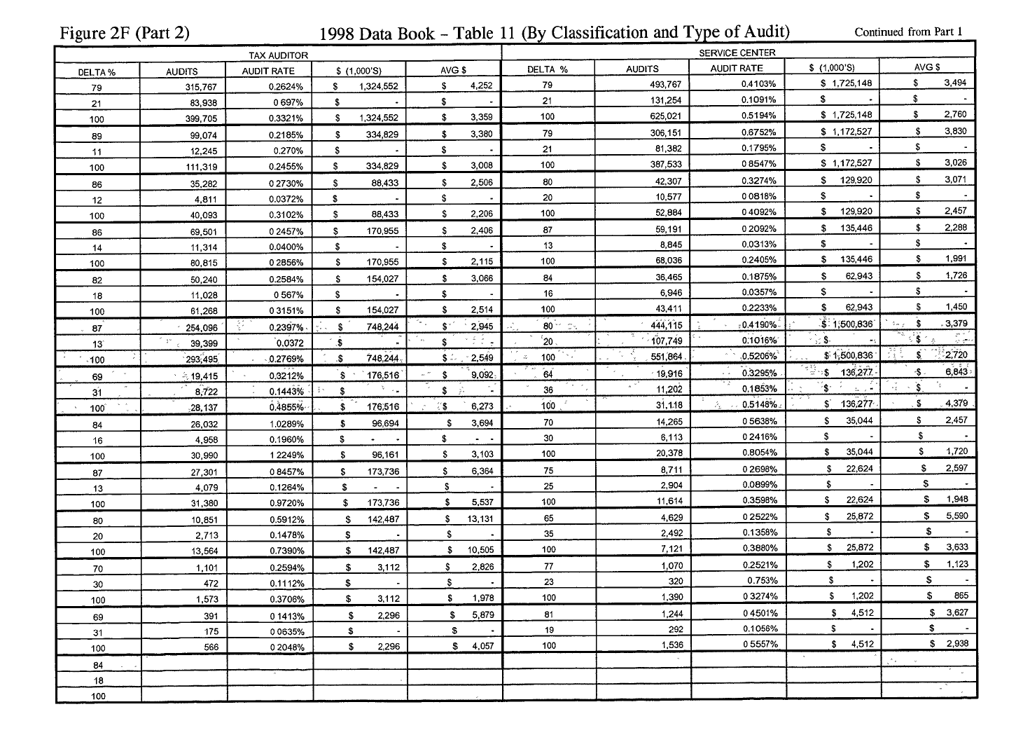

FIGS. 2-14 disclose the components and interactions of preferred embodiments of the present invention. With reference to the Figures, FIG. 2 discloses the high level components (and their interactions with other components and parties) of the preferred embodiment of the present invention in the context of audit protection business and include: (1) Product development and management 200; (2) Marketing including providing an online risk evaluator for tax audit related risks 300; (3) Distribution 400; (4) Issuance 500; (5) Policy administration 600; and (6) Claims processing 700. Several of these components having innovative features in accordance with the present invention and are discussed in greater detail further herein. Other aspects of the tax insurance system are similar to aspects of conventional insurance processing systems that are within the abilities of those skilled in the art and are, therefore, not discussed in great detail herein.

### Product Development and Management

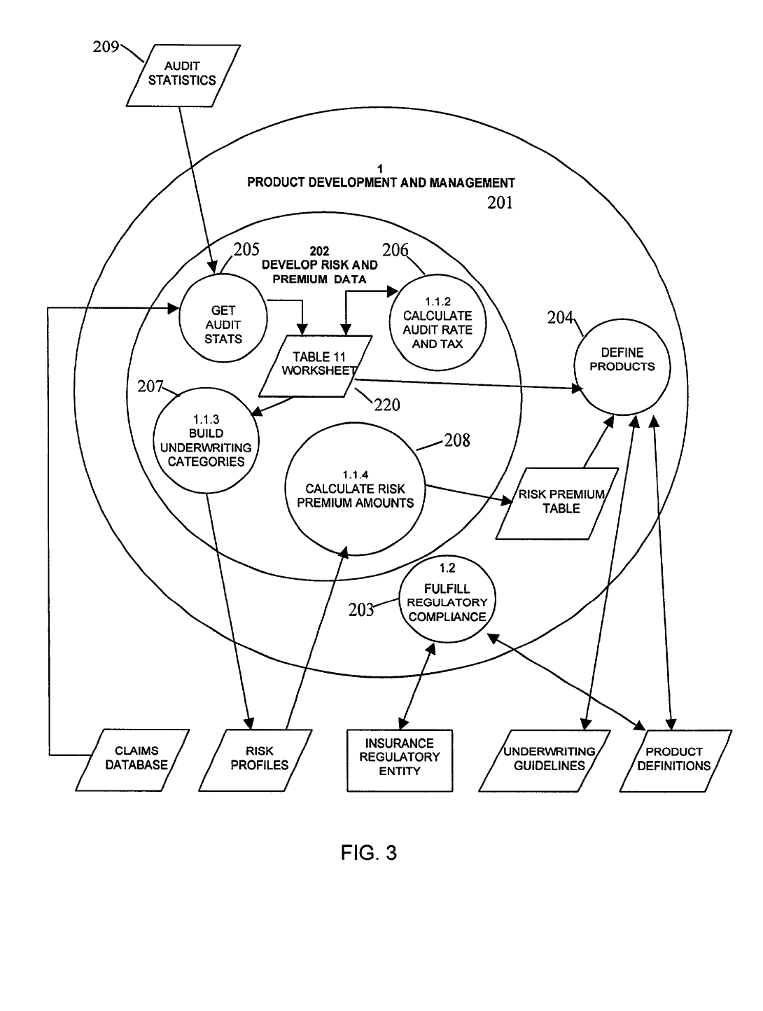

As shown in FIG. 3, the Product Development and Management component 200 includes several sub-components: Develop risk and premium data 202; Fulfill regulatory compliance 203; and Define products 204.

Sub-component 202 develops risk and premium data and includes several functional steps (or components). A Step 205 in sub-component 202 gets or accesses tax audit statistics 209. Typically this information is accessed from public sources or other information provided by a taxing authority. For example, the United States Internal Revenue Service annually produces a “Data Book” that contains tax audit related statistics (including useful information in Table 11 of the Data Book). FIG. 2A shows an example Table 11 (210) published by the Internal Revenue Service (the displayed Table 11 is for the tax year 1997). Other taxing authorities make available similar statistics related to examination, audits, and assessments. Accordingly, it is to be understood that the present invention contemplates using audit related statistics that are provided by a taxing jurisdiction (or authority) whose audit related risks are being insured against. References to Table 11 of the IRS Data Book is just one example of such audit related statistics provided by a taxing authority. It is also to be understood that present invention also contemplates providing for tax audit insurance against audit risks from more than one taxing authority or jurisdiction. In such a situation, the tax audit statistics from each of these jurisdictions may be used to determine tax audit related risks and corresponding premiums.

The present invention also contemplates alternative ways of receiving or computing the tax audit statistics 209 such as receiving it from a third party provider or from accessing a public or private database storing such information.

Typically, the IRS Data Book audit statistics include information such as types and numbers of returns examined, the percentage of returns that are not changed by examination, and the recommended additional taxes and penalties assessed for each type of examination. Furthermore, the audit statistics include such data broken down by several taxpayer and examination related parameters, such as type of return filed, income of the filers, whether particular schedules were filed with the returns, and the type of the filer (for example, individual versus corporations).

In the narrative and Figures to follow, numerous terms will be referenced. A glossary with brief definitions of these terms is provided in the table 211 shown in FIG. 2B.

Step 206 calculates the average audit rate and additional costs (such as additional assessed taxes and penalties) for groups of taxpayers based on taxpayer and examination related parameters. For example, one method of calculating average rate and cost information for groups of taxpayers based on taxpayer and examination related parameters is shown in FIGS. 2C, 2D and 2E and refers to the category worksheet 220 shown in FIG. 2F which is derived from IRS Data Book Table 11 published for the tax year 1998. The category worksheet 220 aggregates information from the IRS Data Book Table 11 for appropriate categories identified in accordance with the present invention. FIG. 2F shows some of the exemplary categories based on taxpayer filing characteristics.

It should also be understood that the term “average” used in this application is a computed figures in accordance with the present invention and includes, in one embodiment, either a mean, median, or mode of the particular parameter(s), such as the audit rate or additional costs, or any combination thereof. Furthermore, it also encompasses any other computed figure (for example, based on a weighted average) that is representative of the parameter for the purposes of the present invention.

In one preferred embodiment, the exemplary calculation steps, calculate audit rate and tax 206, build underwriting categories 207, and calculate risk premium amounts 208 are discussed in the following paragraphs with reference to FIGS. 2C, 2D, 2E, and 2F.

Step 206: Calculate Returns Examined, Audit Rate, and Average Additional Tax for each

Audit Result (‘With Change’ or ‘No Change’) within each [Type Of Return], [Filing Characteristics Subset], and [Type Of Audit Subset] combination. For future reference, this unique combination of qualifiers used to identify specific classes of claims exposure will be referred to as the ‘Classification Key’. That is, the ‘Classification Key’ refers to a combination of the [Type of Return], [Filing Characteristics Subset], and [Type of Audit Subset]. For example, the data for the “Returns examined” column for the listed [Type of Audit Subset] in FIG. 2C corresponds to the total of the Individual categories A-E in the worksheet 220 shown in FIG. 2F.

Substep 1 of step 206: As shown in FIG. 2D, within each ‘Classification Key,’ calculate number of returns examined for each [Audit Result] by prorating (or dividing) the [Returns Examined] for each [Audit Result]. Calculate number of such examined returns resulting in ‘No Change’ ([Number Of Returns No Change]) by multiplying [No Change Percentage] by [Returns Examined]. [Number Of Returns With Change] is derived by subtracting [Number Of Returns No Change] from [Returns Examined]. In an alternate embodiment, the average tax and penalty amounts (per return) as provided in Table 11 could also be used ‘as-is’ to derive the assessment claim exposure information for all audited returns (regardless of [Audit Result]), but in the preferred embodiment the step of segregating the examined returns based on the

Audit Result (‘No Change’ or ‘With Change’) is used to determine more precisely the average assessment claim exposure for an audited return that results in an additional assessment.

Substep 2 of step 206 As shown in FIG. 2D, within each ‘Classification Key’ (‘No Change’ or ‘With Change’), calculate the [Audit Rate for Returns]. [Audit Rate For Returns With Change] is calculated by dividing [Returns Examined With Change] by [Returns Examined]. [Audit Rate for Returns No Change] is calculated by dividing [Returns Examined No Change] by [Returns Examined].

Substep 3 of step 206: As shown in FIG. 2D, within each ‘Classification Key’ and [Audit Result], calculate [Average Tax and Penalty Per Return]. [Average Tax and Penalty For Returns With Change] is calculated by dividing [Recommended Additional Tax and Penalties] by [Returns Examined With Change]. [Average Tax and Penalty For Returns_No Change] is assumed to be zero for purposes of calculating claim exposure.

Optionally, in step 207, appropriate ‘Underwriting Category’ groupings can be defined. Therefore, if desired, multiple [Filing Characteristic Subsets] can be combined into an ‘Underwriting Category’ thereby permitting calculations for the aggregate to be performed in the same manner as that for ‘Classification Key’ and [Audit Result] combination in substep 2 of step 206 . ‘Underwriting Category’ is primarily used to combine [Filing Characteristic Subsets] sharing similar taxpayer profiles into groups for marketing, risk, and pricing purposes. For example, in one embodiment of the invention, ‘Underwriting Category 1’ is developed by combining the first four Individual [filing characteristic subsets] as portrayed in the IRS audit statistics (specifically ‘1040A and TPI <$25,000’, ‘Non-1040A and TPI <$25,000’, ‘TPI between $25,000 and $50,000’, and ‘TPI between $50,000 and $100,000’). Similarly, ‘Underwriting Category 2’ represents strictly the fifth [filing characteristic subset] presented in the IRS statistics as published for example in Table 11 of the IRS’ Data Book (‘TPI $100,000 and Over’). Note that TPI is a measure of taxpayer income.

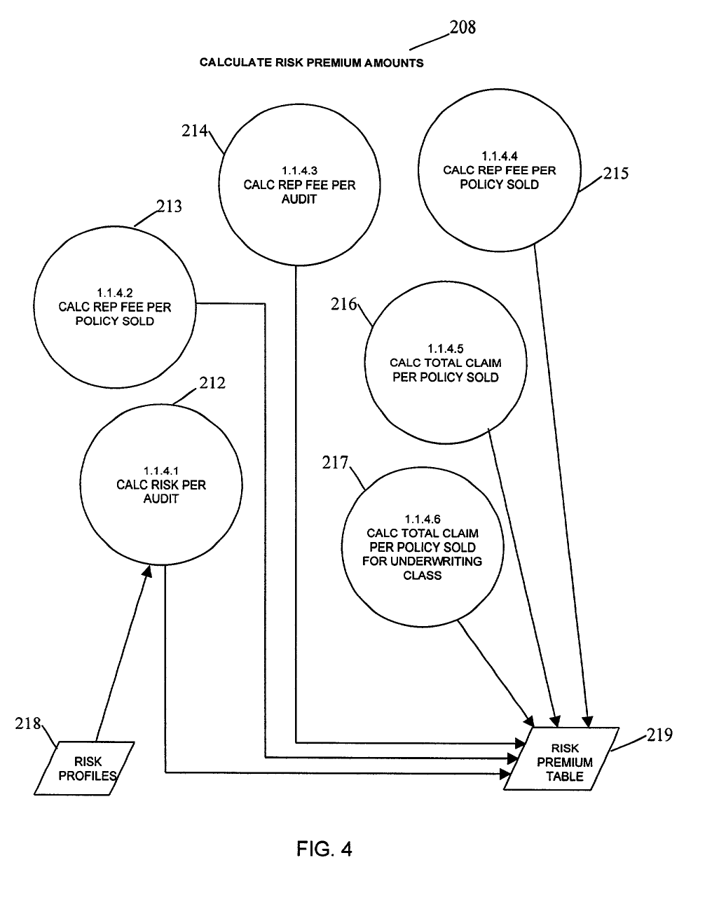

In step 208, risk premium amounts are calculated to cover the additional taxes and representation fees using underwriting principles. With reference to FIG. 4, in one preferred embodiment, the exemplary substeps for calculating risk premium amounts in step 208 are discussed in the following paragraphs with reference to the data shown in FIGS. 2C-2F.

Step 212: As shown in FIGS. 2D and 4, [Actual Assessment Claim Exposure per Audit is derived for each ‘Classification Key’ and [Audit Result] combination through the use of [Audit Rate], [Average Additional Tax and Penalty] and [Policy Limit]. For each such combination, [Actual Assessment Claim Exposure Per Audit] is calculated by taking the lesser of the [Policy Limit] and the respective [Average Tax and Penalty Per Return]. In one embodiment, there may be at least 30 possible combinations of filing characteristics subsets and types of audits for the subset individual income tax returns. The [Average Additional Tax and Penalty] for each of these possible combinations is then compared with the policy limit for each to determine the actual claims exposure for each type of audit and that filing characteristics subset combination. For example, in the instance of Service Center Audits in the fifth [Filing Characteristics Subset] (‘TPI $100,000 and Over’), for policies providing $7,500 in coverage, [Actual Assessment Claim Exposure Per Audit With Change] is derived by taking the lesser of [Policy Limit] ($7,500) and [Average Tax and Penalty Per Return With Change] ($6,843). The resulting risk for this ‘Classification Key’ and [Audit Result] combination is, for example, $6,843. In one alternate embodiment, as shown in FIG. 4, a risk profile 218 based on prior claim data stored by the system of the present invention is used to modify the calculated risk per audit. For example, this risk profile may contain other factors, such as the residence address or profession of a taxpayer, that may influence the risk of audit for a taxpayer. In a further alternate embodiment, the present invention may access this additional risk profile data 218 from a third party that may have compiled such data.

Step 213 As shown in FIGS. 2E and 4, for each ‘Classification Key’ and [Audit Result] combination, calculate [Assessment Claim Exposure per Policy Sold With Change] by multiplying the [Actual Assessment Claim Exposure Per Audit With Change] by the [Audit Rate For Returns With Change]. For example, in the instance of Service Center Audits in the fifth [Filing Characteristics Subset] (‘TPI $100,000 and Over’), for policies providing $7,500 in coverage,

Assessment Claim Exposure Per Policy Sold With Change ($22.54) is derived by multiplying [Actual Assessment Claim Exposure Per Audit With Change] ($6,843) by [Audit Rate For Returns With Change] (0.00329471).

Step 214: As shown in FIGS. 2E and 4, for each ‘Classification Key’ and [Audit Result] combination, calculate [Actual Representation Claim Exposure Per Audit] by taking the lesser of the [Representation Limit] and the result of subtracting the [Actual Assessment Claim Exposure Per Audit] from the [Policy Limit] for the respective ‘Classification Key’ and

Audit Result combination. For example, in the instance of Service Center Audits for the fifth [Filing Characteristics Subset] (‘TPI $100,000 and Over’), for policies providing $7,500 in coverage, [Actual Representation Claim Exposure Per Audit With Change] ($657) is derived by taking the lesser of [Representation Limit With Change] ($300) and [Policy Limit Remainder] ($657) which is calculated by subtracting [Actual Assessment Claim Exposure Per Audit With Change] ($6,843) from [Policy Limit] ($7,500). The resulting [Actual Representation Claim Exposure Per Audit With Change] for this ‘Classification Key’ and [Audit Result] combination is therefore $300.

Step 215: As shown in FIGS. 2E and 4, for each ‘Classification Key’ and [Audit Result] combination, calculate [Representation Claim Exposure per Policy Sold] by multiplying the [Actual Representation Claim Exposure Per Audit] by the [Audit Rate For Returns]. For example, in the instance of Service Center Audits for the fifth [Filing Characteristics Subset] (‘TPI $100,000 and Over’), for policies providing $7,500 in coverage, [Representation Claim Exposure Per Policy Sold With Change] ($0.988) is derived by multiplying [Actual Representation Claim Exposure Per Audit] ($300) by [Audit Rate For Returns With Change] (0.00329471).

Step 216: As shown in FIGS. 2E and 4, For each ‘Classification Key’ and [Audit Result] combination, calculate [Combined Assessment and Representation Claim Exposure Per Policy Sold] by summing [Assessment Claim Exposure Per Policy Sold] and [Representation Claim Exposure Per Policy Sold]. For example, in the instance of Service Center Audits for the fifth [Filing Characteristics Subset] (‘TPI $100,000 and Over’), for policies providing $7,500 in coverage [Combined Assessment and Representation Claim Exposure Per Policy Sold With Change] ($23.53) is calculated by adding [Assessment Claim Exposure Per Policy Sold With Change] ($22.54) and [Representation Claim Exposure Per Policy Sold With Change] ($0.99).

Step 217: As shown in FIGS. 2E and 4, calculate

Total Claim Exposure Per Policy Sold for the entire [Filing Characteristics Subset] by summing the Total Claim Per Policy Sold for all ‘Classification Key’ and [Audit Result] combinations. For example, for the fifth [Filing Characteristics Subset] (‘TPI $100,000 and Over’), for policies providing $7,500 in coverage, [Total Claim Exposure Per Policy Sold] ($96.352) is calculated by adding [Combined Assessment and Representation Claim Exposure Per Policy Sold] for Revenue Agent Audits No Change ($1.11), Tax Auditor Audits No Change ($2.16), Service Center Audits No Change ($0.37), Revenue Agent Audits With Change ($45.08), Tax Auditor Audits With Change ($24.09), and Service Center Audits With Change ($23.53). The resultant value, [Total Claim Exposure Per Policy Sold], for each [Filing Characteristics Subset] is instrumental in developing ultimate pricing decisions for the respective products and may be stored in the risk premium table 219 since this value is very useful in determining the premiums to be charged, for example, based on underwriting and product development considerations that are known to those skilled in the art.

With reference to FIG. 3, in step 203, the processes through which the tax and tax audit insurance products are designed and developed in conjunction with their supporting documentation and system interfaces and components are provided.

In step 204, the regulatory interactions and approvals are completed so that the tax and tax audit insurance products can be offered to taxpayers. If required, any regulatory approvals or clearances for online offering or joint marketing of these products are also obtained.

### Marketing Including Providing an Online Risk Evaluator

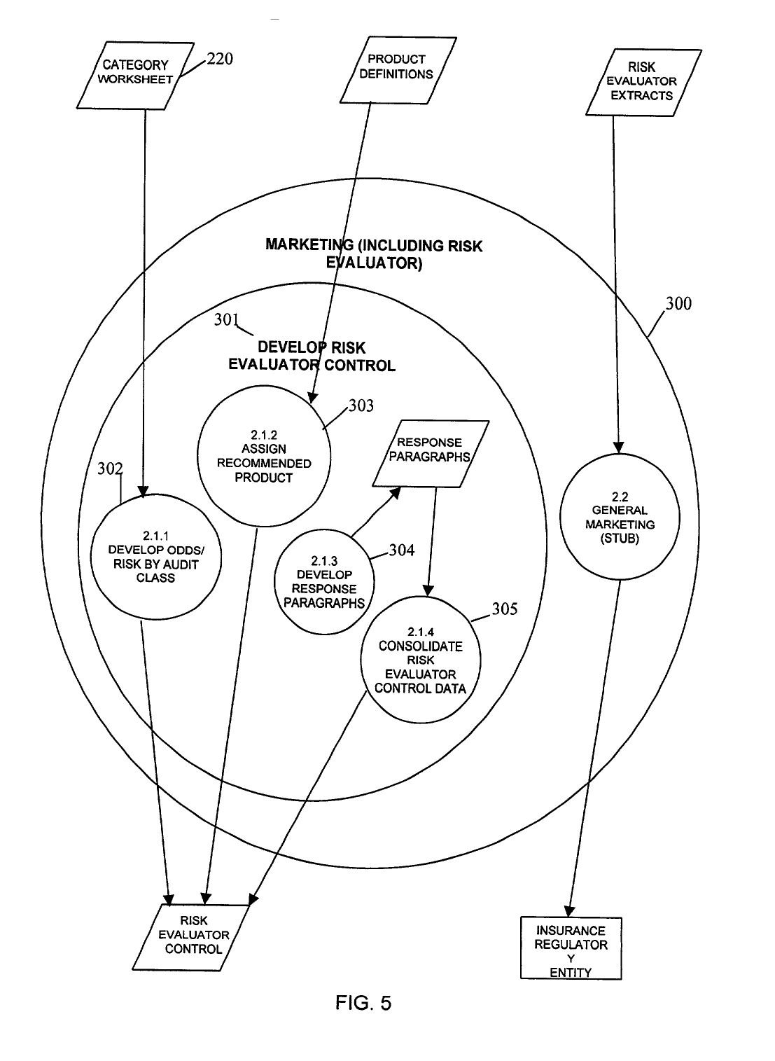

As shown in FIG. 5, component 301 develops the framework for the response information (Odds, Average Risk, Recommended Products, and Custom Paragraphs) generated by an online risk evaluator provided by the present invention. The risk evaluator acquires filing characteristics information from the taxpayer input data into the risk evaluator (for example, by compiling or processing responses to a questionnaire), then determines and displays the probability that the taxpayer's return will be audited as well as the average additional costs associated with a tax audit. As discussed earlier, the additional costs may include one or more of additional assessed taxes, interest on the additional assessed taxes, and penalties. Furthermore, the risk evaluator may also calculate and provide average or typical representation costs based on one or more of taxpayer or examination related parameters. For example, the risk evaluator may calculate average representation costs for parameters that include one or more of types of audits, taxpayer income, type of filer (individual or corporation), types of schedules filed, etc.

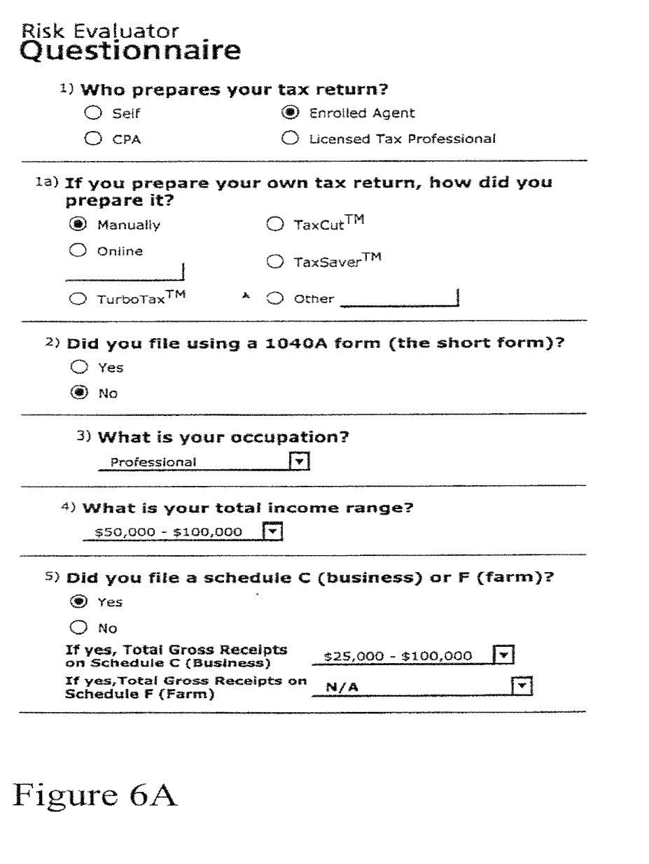

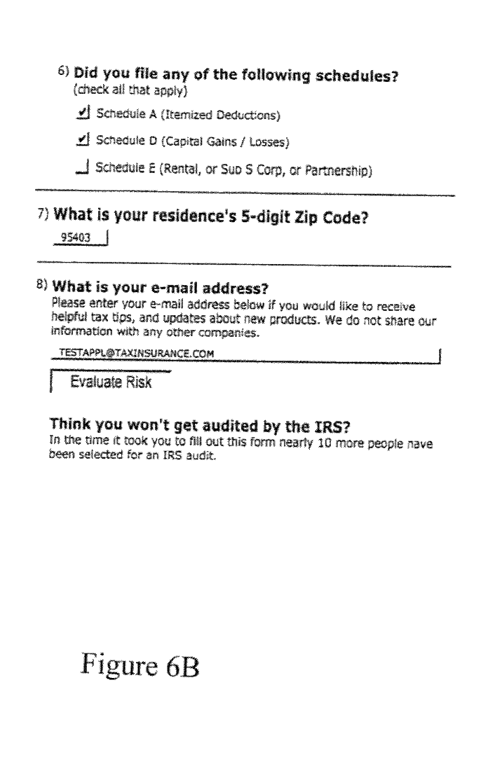

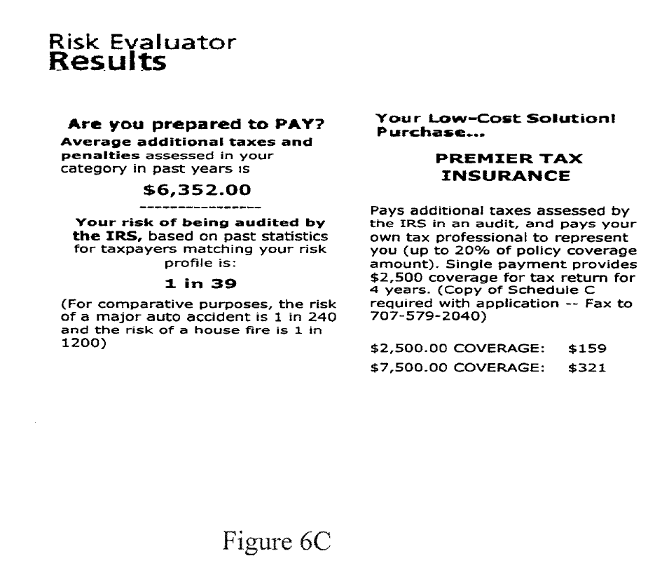

The data required by the risk evaluator can be acquired by capturing the taxpayer responses to a risk evaluator questionnaire. An exemplary set of questionnaire and data collected from it is disclosed in FIGS. 6A-6B. As seen from FIGS. 6A-6B, some of the exemplary data collected includes who prepared the tax return, whether a short form was filed, occupation for the taxpayer, the total income range, whether particular schedules were filed with the tax return, and the geographic location of the taxpayer. In addition, as seen from FIG. 6C, the risk evaluator can then display a customized response based on the exemplary data collected through the questionnaire.

It is to be understood that the data collected discussed here is exemplary only and other similar data relevant to assessing a risk associated with tax audits can also be collected. Furthermore, in the preferred embodiment, the data is entered online by a taxpayer (for example by accessing a website associated with the provider of the present invention), however, other methods of accessing taxpayer related information are also contemplated by the present invention. For example, the taxpayers may also provide the information by mail or through an application for a product associated with the present invention, such that the information is accessible either directly or through a communication network utilized by the method and system of the present invention. Alternatively, as discussed further herein, the tax audit risk evaluator may be bundled with a tax preparation service or software so that the risk evaluator may access any necessary taxpayer related data stored by the tax preparation service or software.

In a preferred embodiment, the data required to support the risk evaluator functionality 301 is developed using the steps (or components) discussed in the following paragraphs.

Step 302: Develop probability claim exposure for each filing characteristics subset. In the present invention, a ‘Risk Category’ (assigned numerically, for example) is defined for each filing characteristics subset derived from the IRS Data Book audit statistics. This information supports the probability and monetary risk portion of the response displayed after the Risk Evaluator Questionnaire is completed and submitted over the electronic network.

Probability of audit is calculated by dividing 100 by the Audit Rate for the applicable Audit Class as illustrated in a Category Worksheet (See FIGS. 2F). The desired Audit Rate is found at the intersection of the ‘ALL’ row and the ‘Audit Rate’ column in the Total Section for the applicable Audit Class. For example, the odds for Audit Class ‘A’ (‘1040A−TPI<$25,000’) is 1 in 88, which is calculated by dividing 100 by the applicable Audit Rate (0.011358 or 1.1358%)

For the Risk Evaluator, the Average claims exposure for each filing characteristic subset is derived by multiplying the Additional Tax and Penalties by the filing characteristics subset as illustrated in the Category Worksheet (FIGS. 2F). The desired Average claims exposure is found at the intersection of the ‘ALL’ row and the ‘Avg $’ column in the Total Section for the applicable filing characteristics subset. For example, the expected claims exposure for Audit Class ‘A’ (‘1040A−TPI<$25,000’) is $3,279.

Step 303: Assign Recommended Product for each [Underwriting Category] and obtain available premium rates for that product. This information comprises the Recommended Product portion of the response displayed after the Risk Evaluator Questionnaire is submitted.

Step 304: Develop custom, uniquely identified, Risk Evaluator Response Paragraphs to address Tax Insurance availability, Return Preparation Method, Income, Schedule C and/or F status, and status of 1040A form as well as presence or not of Schedules A, D and E. These paragraphs will be used, on a selected basis, to build customized responses to the Risk Evaluator questionnaire.

Step 305: Consolidate Odds, Risk, Recommended Product and Custom Paragraphs into a database to be accessed by the Risk Evaluator that drives the response to Risk Evaluator Questionnaire. Some of the substeps (or components) of this step are discussed in the following paragraphs.

Substep 1 of step 305: Create primary matrix of criteria to itemize and prioritize Response Paragraphs based on data pertaining to Method of Tax Return preparation and whether or not Tax Insurance is available in the user's resident state. The user's state of residence is based on the zip code provided in the Risk Evaluator Questionnaire.

Substep 2 of step 305 Create secondary matrix of criteria to itemize and prioritize Response Paragraphs pertaining to Income and presence of Schedule C and/or Schedule F on the user's tax return. The secondary matrix is also used to assign the user to a Risk Category for which the Odds, Average Additional Tax, Recommended Plan and applicable premiums are provided for retrieval in preparing the Response Page for the Risk Evaluator.

Substep 3 of step 305: Create the third and final matrix of criteria to itemize and prioritize, if applicable, Response Paragraphs pertaining to the inclusion, or not of Form 1040A, Schedule E, Schedule D and/or Schedule A in the user's tax return. For each combination of criteria specific paragraphs are designated to be included in the Response Page for the Risk Evaluator.

### Distribution/Sales Management

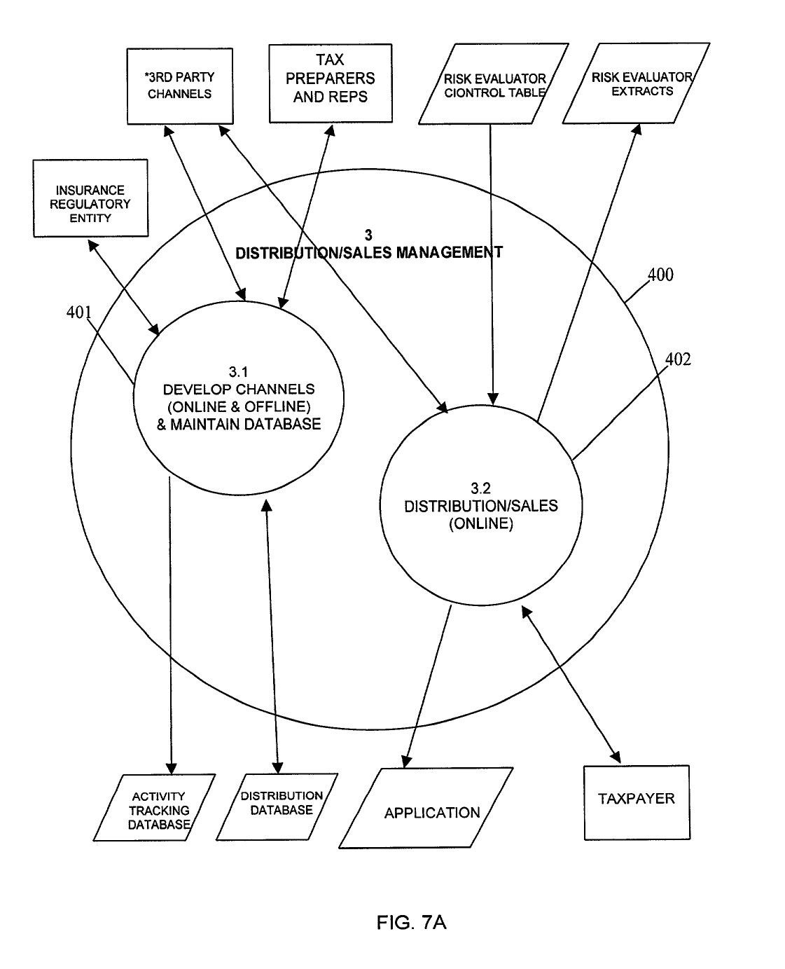

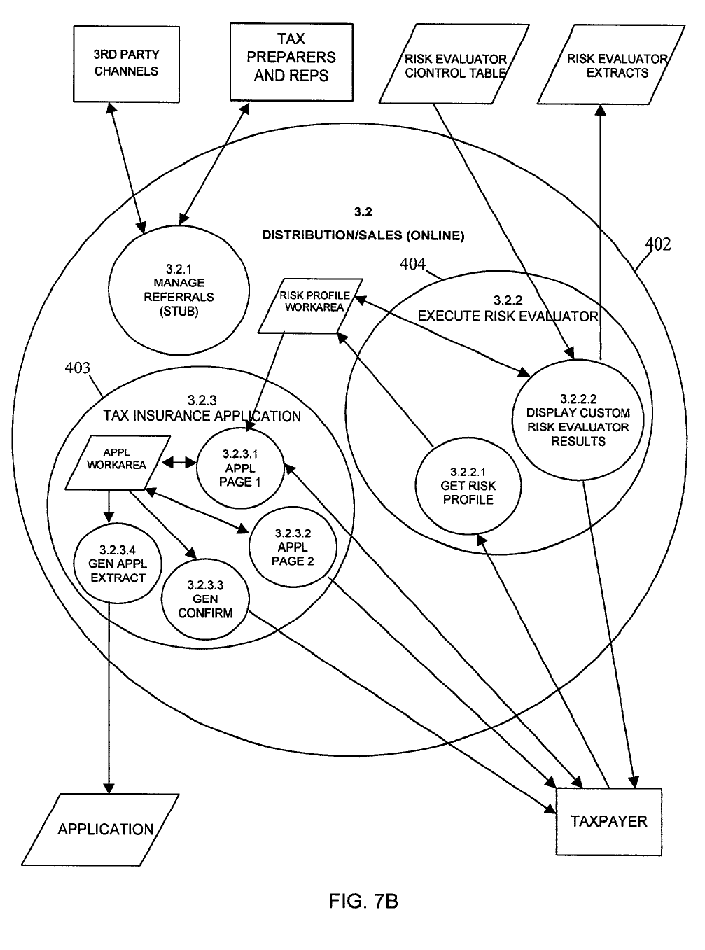

FIGS. 7A and 7B show different components of the network communication system used by the customers of audit protection insurance or members of an affinity group (such as American Tax Payers Association enrollees/members) in the current preferred embodiment. Accordingly, component 401, as illustrated in FIG. 7A provides the processing logic (and data management and storage) to service the multiple third party channels of distribution in the preferred embodiment or any alternative embodiment. In the preferred embodiment, the third party channels of distribution include, for example, third party tax preparers, or providers of computer programs to prepare tax returns for individuals or groups. Such computer programs can be delivered on an electronic storage medium (CD-ROMs, etc.) or through the Internet (or other electronic network) by downloading or use of server technology accessible by using an application programming interface or similar delivery method designed to gather information.

Similarly, if the customer's information necessary to determine the taxpayer's Filing Characteristics Subset is provided through an affinity group or association as a membership benefit to a group of employees, the present invention provides networked components designed to gather the necessary taxpayer information, provide it to the underwriting program, process it, and either reject the application or issue the membership benefit certificate or applicable tax audit insurance policy.

As shown in FIG. 7B, an online distribution and sales component 402 provides for integrating an application process component 403 (for the tax insurance) to the risk evaluator component 404 (that uses, for example, the logic of component 301 discussed earlier herein). Therefore, the risk evaluator component 404 acquires taxpayer information and provides a customized risk profile to the taxpayer based on taxpayer's type of return, income level and sources of income and deductions, plus past audit experience and filing status. These are compared with the taxing authority's past auditing data (such as that provided by Table 11 of the IRS Data Book). FIGS. 6A and 6B provide exemplary illustrations of the Risk Evaluator questionnaire (page 1 and page 2) and FIG. 6C provides an exemplary illustration of the response display used, by the present invention to provide recommended tax insurance products to the taxpayer based on the taxpayer and examination information so that the tax insurance application process component 403 can complete the application process with suitable interactive input from the taxpayer.

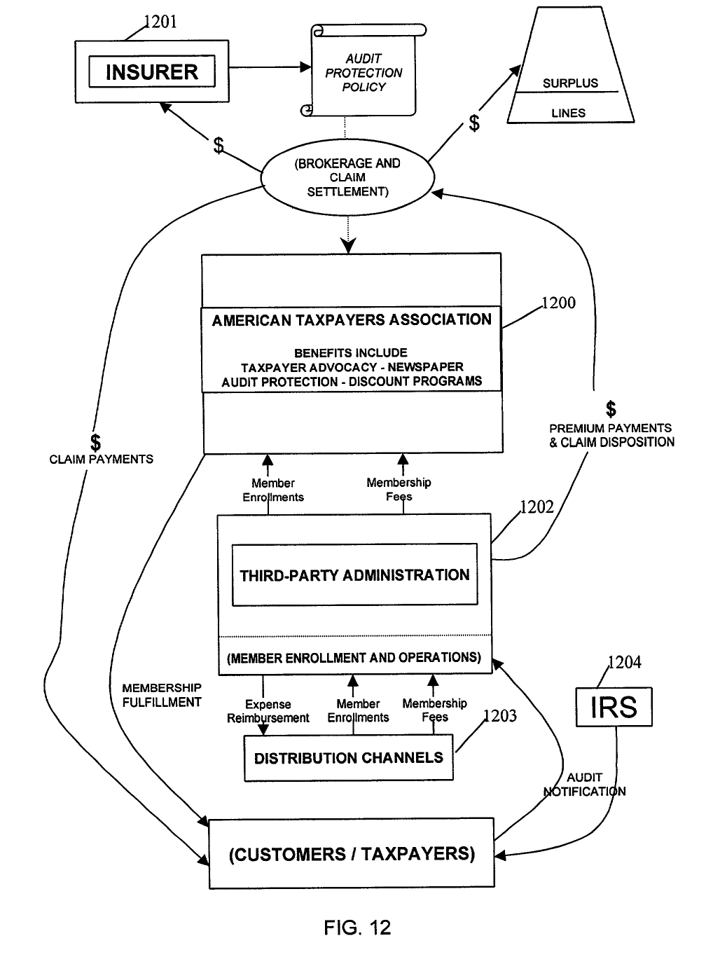

Given the number of distribution channels and potential third party distributors within each channel, the current invention has a large number of alternative embodiments. Each of these is designed to comply with the insurance sales management laws and regulations of the country, province, or state in which the potential customer resides or is subject to income taxation by the relevant taxing authority. In the preferred embodiment, the present invention contemplates the use of a group master policy to sell a surplus lines insurance policy to a membership organization that provides multiple levels of membership benefits and tax audit insurance. This feature is illustrated in FIG. 12 and discussed further herein.

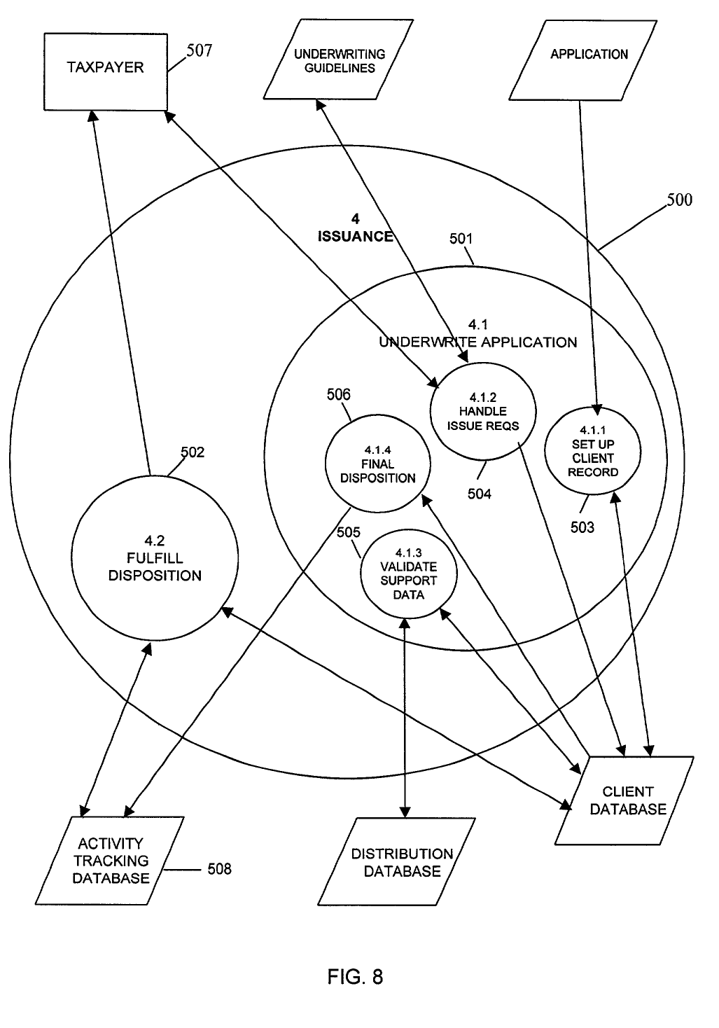

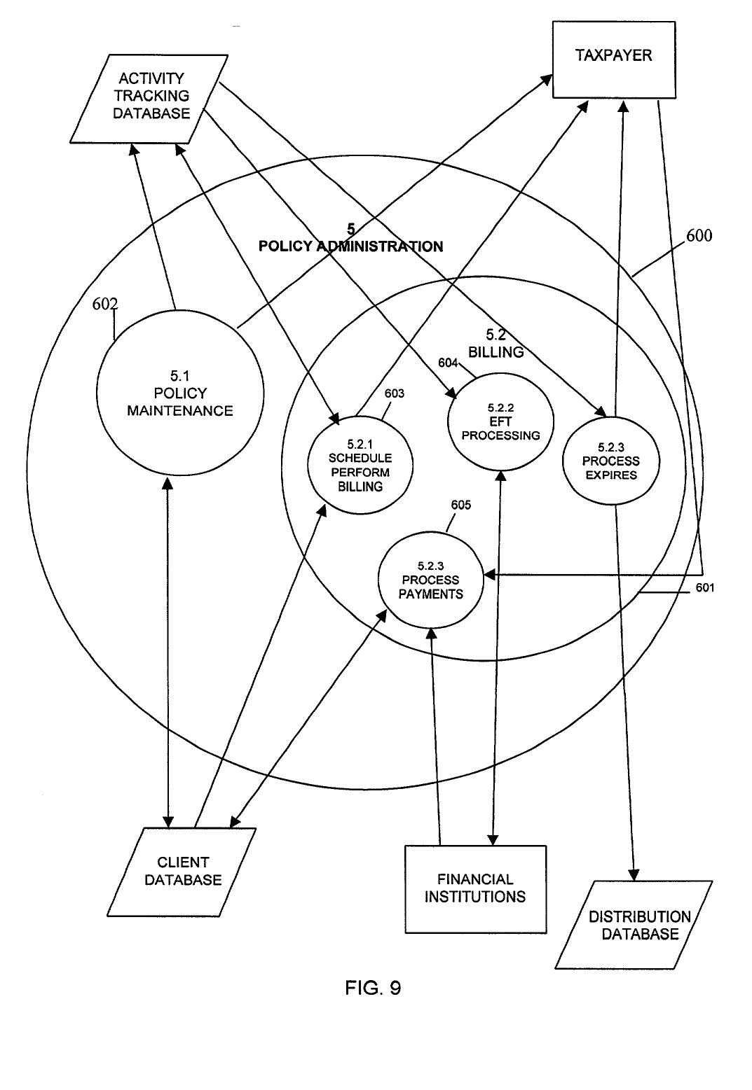

FIGS. 8 and 9 disclose high level components of the insurance issuance and policy administration aspects of the present invention. These issuance and billing aspects are clear from the figures and are, therefore, not discussed in detail herein. For example, as shown in FIG. 8, the issuance process 500 includes the steps of: underwriting the application 501; and fulfilling the disposition 502 determined when underwriting the application 501. The underwriting the application process 501 may include the steps of: setting up a client record 503; handling issues requirements 504 (administrative, regulatory, for example); validating the support data 505; and making a final disposition 506. The step of fulfilling the disposition 502 may include communicating with the taxpayer (or client) 507 and updating databases, for example, an activity tracking database 508.

As shown in FIG. 9, the policy administration component 600 includes components for billing 601 and for policy maintenance 602. The billing component 601 may include components that perform one or more of the following tasks: schedule and generate bill to client (or paying entity) 603; receive funds from client 604 (for example, by Electronic Funds Transfer); process payments 605 by allocating the received funds to the policies of the appropriate clients; and process expiration of policies 606 for example, by generating reminders and appropriately processing client instructions regarding policies that are expiring.

### Claims Administration

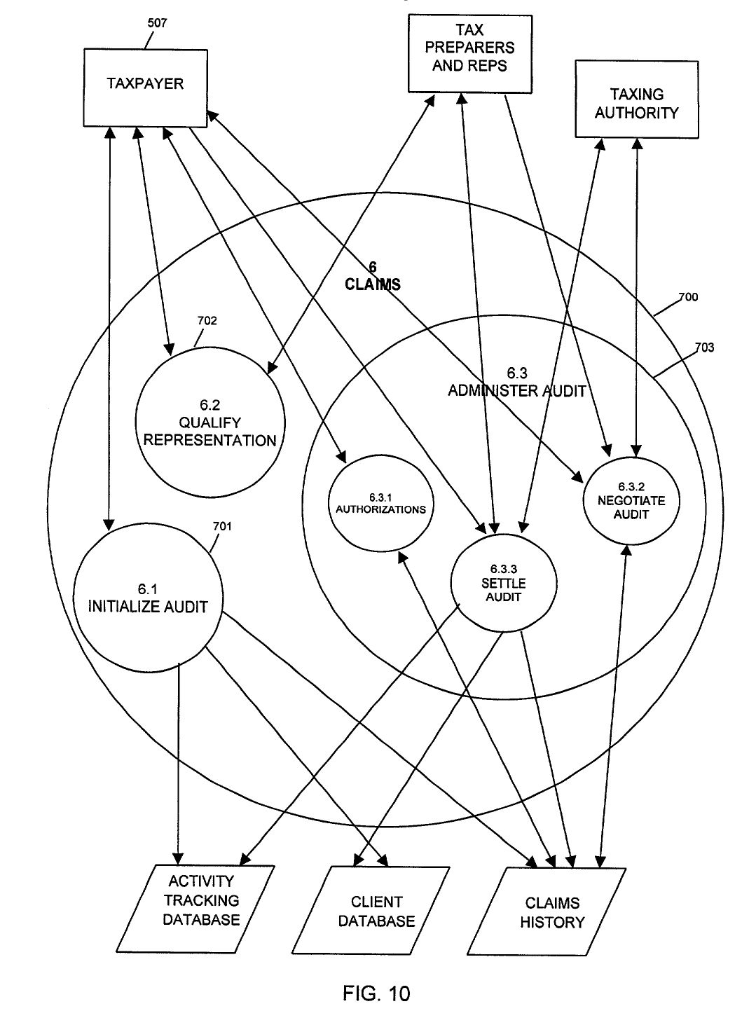

FIG. 10 is a high-level dataflow diagram of the Claims Administration component 700 of the tax audit insurance system of the present invention. In step 701, an initialize audit process 701 is initiated by a communication by a taxpayer 507 that is being audited by a taxing authority. In step 702, professional representation of the taxpayer 507 before the taxing authority is qualified. Finally, the audit is administered in step 703.

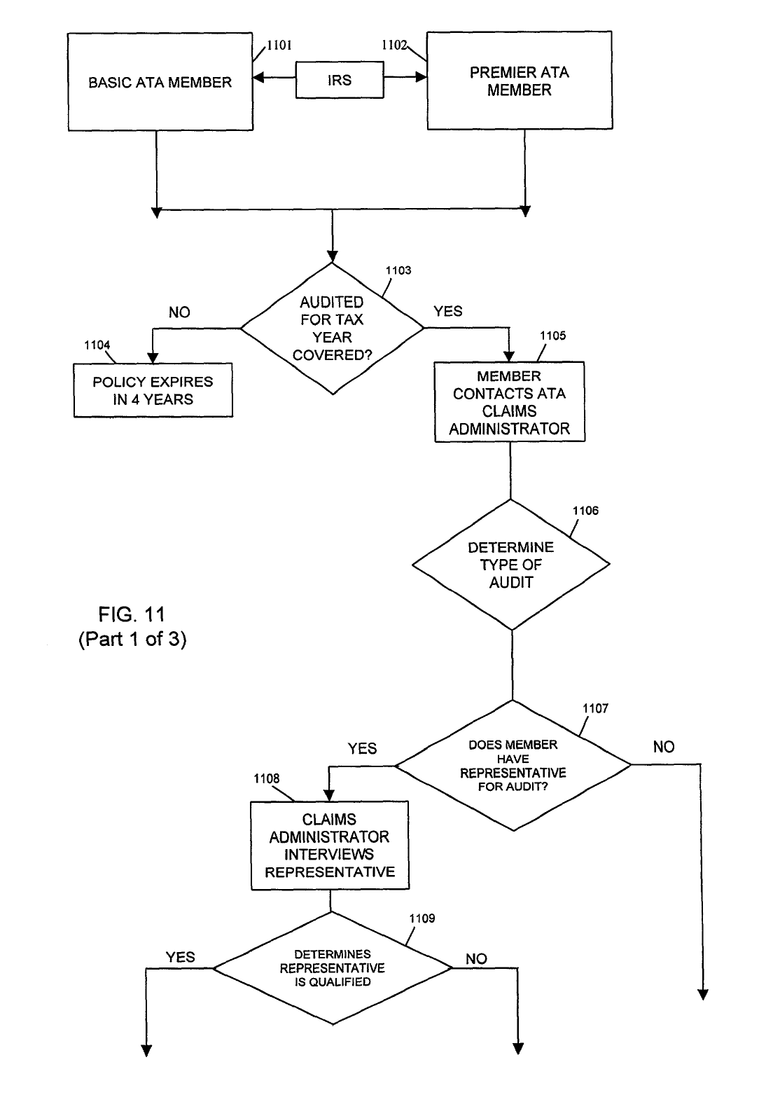

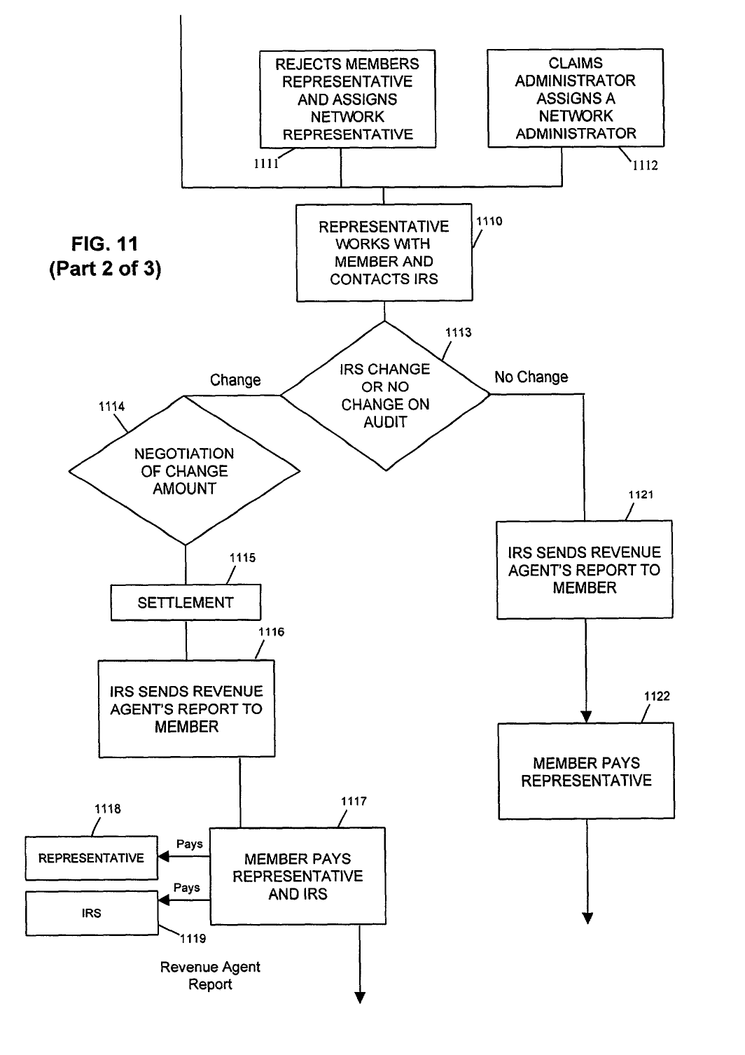

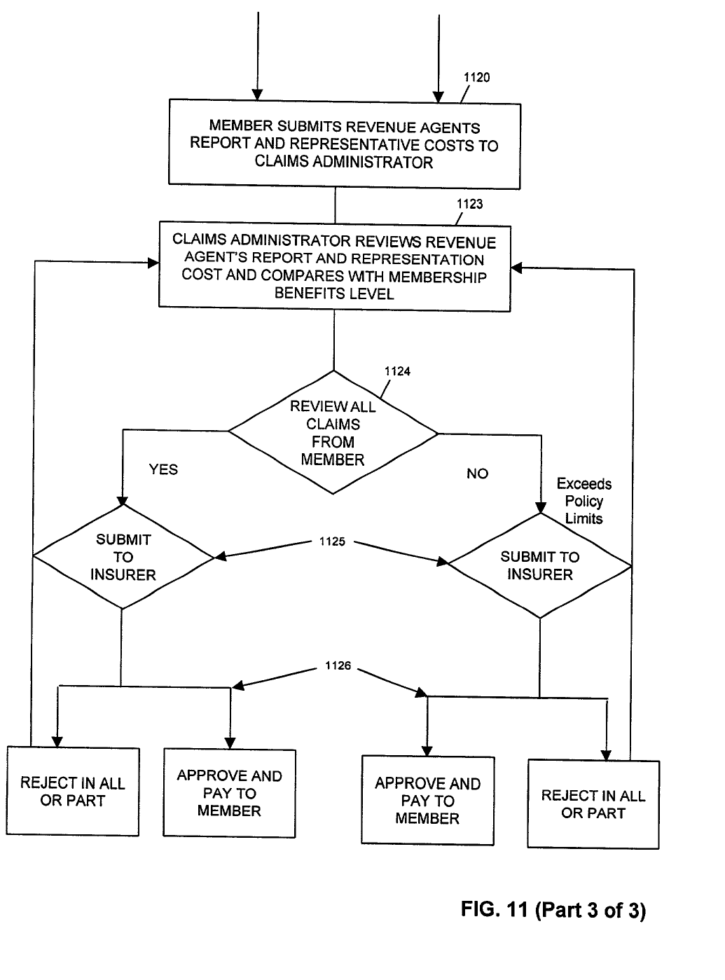

FIG. 11 provides a procedural flow chart of a preferred embodiment of the claims administration process. In this embodiment, two members covered by the tax audit insurance according to the present invention are contacted regarding an audit in steps 1101 and 1102. In this preferred embodiment, the members are covered under a group insurance policy offered through an association, for example, American Taxpayers Association (ATA) as discussed further herein with respect to FIG. 12. In step 1103, a determination is made whether the audit is for a tax year covered by the tax audit insurance policy. If not, the policy expiration is noted and the process terminated in step 1104. If yes, the member contacts the claims administrator in step 1105.

As discussed further herein, the claims administrator can be a third party or the administration can be done by an association, such as the ATA, through which the insurance is provided to members of the association. In step 1106, the type of the audit is determined. In step 1107 a determination is made about whether the member has a professional representative. If yes, in step 1108 a claims administrator communicates with the representative and in step 1109 determines whether the representative is qualified. If the representative is not qualified in step 1109 or if the member does not have a representative in step 1107, a representative is assigned for the audit in steps 1111 and 1112, respectively.

Thereafter, the process proceeds to step 1110 in which the representative works with the member and communicates with the IRS (or other taxing authority). In step 1113, the IRS (or other taxing authority) changes the tax assessment, the process proceeds to steps 1114-1119 to negotiate and settle the amount of the change and then the member pays both the IRS and the representative. Thereafter, in step 1120, the member submits the revenue agent's report and representative costs to the claims administrator.

If in step 1113, the IRS determines that there is no change in the assessment, the IRS sends a revenue agent's report to the member who then pays the representative in step 1122. Thereafter, the member submits the revenue agents report and the representation costs to the claim administrator in step 1120. In step 1123, the claims administrator compares the revenue agents report and the representation costs and compares to the benefits payable according to the member's policy. Furthermore, the claims administrator reviews all claims from that member in step 1124 and proceeds to steps 1125 and 1126 in which the payment information is forwarded to the insurer to either reject or make partial or complete payment to the member in accordance with the members policy limit and the cumulative assessment and representation costs.

The claims administration demonstrated in this preferred embodiment may be followed in all of the claims administration methods regardless of the sales distribution channel or whether the audit protection policy is an admitted policy or sold as on surplus lines basis. The preferred, and all alternative, embodiments in the current invention use similar methods and systems preprocessing a claim from an insured who has been audited by the relevant taxing authority. The insured's notification of the audit to the claims administrator, the selection of the qualified representative to represent the insured, the negotiations with the taxing authority on behalf of the insured by the authorized audit representative, the payment of the agreed upon tax adjustment and the representative by the insured, and the reimbursement of the insured up to the policy limits for the audit and representation costs, may be similar in all embodiments. Similarly, the communications network and transmission of claims administration data may be similar in all embodiments.

In one preferred embodiment, the insurance is marketed in the United States, which regulates insurance activities at the state level. This results in 50 individual state statutes and regulatory bodies. These are often similar, but not always identical in their regulatory framework.

### Distribution Channels

In one preferred embodiment of the present invention, there are five distinct distribution channels that are utilized to introduce the tax audit insurance product, solicit policy applications, provide a communications network to underwrite the policies and issue the policies to the taxpayer. They are:

Tax Preparers, almost all of whom use a computer program or Internet based system to calculate the tax liability of the tax filer and submit the return electronically. Typically, these involve a third-party tax professional who assists the taxpayer in collecting their data, determining the amount of income from each source, the applicable taxes, e.g. Alternative Minimum Tax, the deductions that the taxpayer is entitled to take, and whether the tax payer is entitled to any credits against their tax liability such as Child Care or Earned Income Credit. After completion of the tax return, with the tax return filer, they can apply for an audit protection insurance policy in a manner which may or may not be integrated into the software used by the tax professional to prepare the individual's tax return. For example, the tax preparation software could have a button or other indicator that allows for the selection of the tax audit insurance according to the present invention. Once selected, the tax insurance product could access the taxpayer and filing characteristics related information that may already have been captured by the tax preparation service or software in order to efficiently provide the tax audit insurance provided in accordance with the present information.

Individual Filers Using a Computer Program, where the individual prepares his or her own tax return without the assistance of a third-party professional, but with the use of a computer program to assist (for example, by prompting or providing context sensitive help) the taxpayer to fill out the form correctly and calculate the appropriate resulting tax for the individual filer. The individual filer then purchases an audit protection insurance policy, which may or may not be integrated into the software used by the individual to prepare their tax return.

Individual Filers Using Direct Internet Sales, where an individual taxpayer prepares their return manually, then purchases the audit insurance from a web site that provides either a program to download to the individual's computer or an interactive interface that the individual uses online to provide information necessary to complete the underwriting and have the policy issued.

Association Membership or Affinity Group, where an individual or corporation becomes a member of an association or affinity group, and as part of the benefits of joining the association or affinity group, the individual or corporation (taxpayer) receives audit insurance protection along with other benefits provided by the association. In this situation the association purchases the audit protection insurance for its members who are the beneficiary of the association's insurance policy, if the association member is audited.

Voluntary Employee Benefit, where an employee of a corporation or an organization, e.g. a state government, voluntarily elects to have the premium deducted from their paycheck on a periodic basis to provide audit insurance protection to the employee.

It should be noted that an established (or conventional) distribution channel may also be used. This could comprise either a company or an agency sales force that makes individual sales of the company's insurance products, e.g. a licensed Allstate agent that sells a variety of all state personal lines policies in the state where that agent is licensed to sell, e.g. Virginia. Such conventional distribution channel of company agents or a company sales force can also be used to sell the tax audit insurance provided according to the present invention.

In any of these distribution channels an alternative embodiment is to bundle the tax preparation service, whether a third-party or a computer program, with audit insurance to cover the individual's potential audit exposure by the relevant taxing authority. The bundled product of the tax preparation and audit protection insurance can be marketed through any of these distribution channels, although the preferred embodiment is to market it as an employee benefit.

Some aspects of these additional distribution channels are discussed in further detail herein. As shown in FIG. 12, the present invention provides an association 1200, for example, the American Taxpayers Association (ATA), that establishes a group master tax insurance policy with an insurer 1201 for providing tax insurance to the members of the association as a benefit of membership with the association. The insurer 1201 can be a “surplus line carrier” who is not admitted to sell insurance in that state, since there is unlikely to be an admitted carrier for such an insurance. Furthermore, such an association 1200 may be chartered in a single state while the members of the association 1200 may reside in any of the states. Furthermore, the association 1200 can then sell their membership products and services including the tax insurance benefit through the Internet or through other electronic means across the country while being chartered in only one state. Therefore, the association 1200 can avoid the expense, inconvenience, and time required to become an admitted carrier in multiple states while offering the tax insurance benefits to the members of the association 1200 after the association 1200 has been chartered in one state.

As shown in FIG. 12, the association 1200 can use a third party administration entity 1202 to administer the membership and benefits payment processes of the association 1200. It should be understood that while the third party administration entity 1202 is shown as a separate entity, its functionality could be provided by any of the parties involved in the provision of the tax insurance product according to the present invention. Therefore, for example, the third party administration entity 1202 can enroll members and collect membership fees from any of the distribution channels 1203 (as discussed earlier herein) that is used to sell the tax insurance according to the present invention. The information relating to the member enrollments and the membership fees are transmitted by the third party administration entity 1202 to the association 1200. The association 1200 provides the membership fulfillment to the members and expense reimbursements are transmitted to the distribution channel entities through the third party administration entity 1202.

When the IRS notifies the member of an audit, the audit notification is transmitted to the third party administration entity 1202 which is also notified of any claim dispositions. The third party administration entity 1202 transmits the claim disposition to the insurer 1201 so that the claim payments can be made to the members.

In one embodiment of the invention, the third party administration entity 1202 has to calculate the premium payments from the membership fees paid by members so that the correct premium is allocated to the insurance with the remainder of the membership fees being provided to the association 1200. Furthermore, entities in the distribution channel, or the third party administration entity 1202 may also be required to aggregate the premium payments for multiple members that may be signed up by one or more entities in the distribution channel 1203.

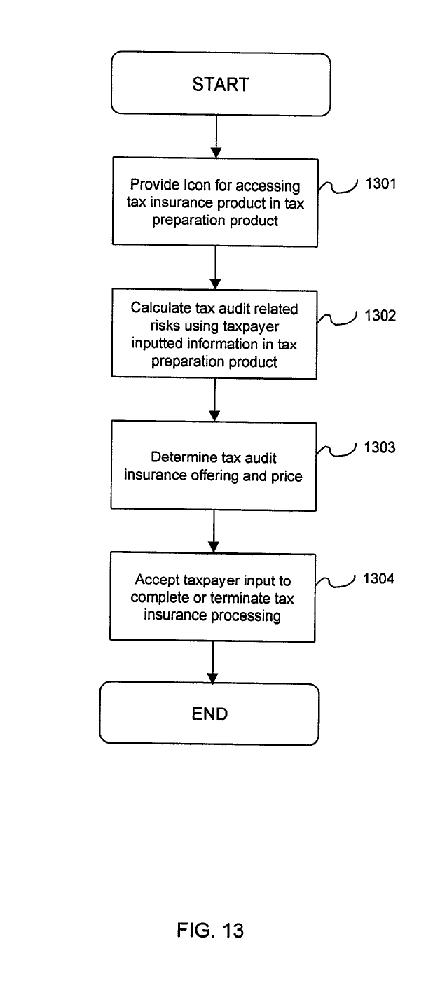

FIG. 13 is a flowchart illustrating the steps for automatically associating the tax insurance with an automated tax preparation service as one example of bundling the tax insurance product according to the present invention with different distribution channels. Such an automated tax preparation service can be provided by a third party provider or can also be tax preparation software sold on a computer storage medium (CD-ROMS, floppy disks, etc.) or accessed online by an electronic network, such as the Internet. Furthermore, it is to be understood that the electronic network can be accessed by a personal computer, a laptop, a wireless device using any user interface.

In step 1301, the automated tax preparation software provides an icon (or other indication) that allows a taxpayer to select the tax insurance option. In step 1302, the selected taxpayer related information entered (and stored) by the tax preparation software is accessed and the risk associated with the particular taxpayer is calculated as discussed previously, for example. The information for risk calculation is of the type mentioned previously for the calculation of risk and premium. In step 1303, a determination or calculation is made to determine whether to offer the taxpayer tax audit insurance and/or the premium rate to be charged for such tax audit insurance. For example, if a flat policy amount is offered at a fixed price, a yes or no determination can be made as to whether the tax insurance should be offered based on a comparison of the taxpayer's risk to a preset threshold of risk. On the other hand, if a flexible policy amount is to be offered, a calculation of both the maximum policy amount and the premium to charged can be performed. The results of the determination in step 1303 is displayed to the taxpayer in step 1304 so that the taxpayer can decide whether to accept or decline the offered coverage, if any. The taxpayer related information that can be used for such a determination and calculation can include, for example, the taxpayers income, the type of income, whether the taxpayer filed certain schedules, etc. The actual risk and premium calculation for the tax audit insurance can be performed similarly to that discussed earlier herein by comparing the taxpayer and filing information risks associated with taxpayer information and filing characteristic subsets derived from examination and taxpayer profile information periodically published by appropriate taxing authorities (such as the Table 11 published annually in the IRS Data Book).

In another aspect, the present invention provides that the tax insurance provided by the present invention can be integrated with a tax preparation product, for example, a computerized tax preparation product that can be sold on a data storage medium or provided or accessed electronically, for example, through the Internet or other electronic network. Therefore, the present invention provides that the tax preparation product can be integrated with the tax insurance so that information inputted and used for tax preparation can also be used to provide tax insurance. For example, the tax insurance can be individually priced in the manner described previously, based on information inputted during tax preparation, for example, the characteristics of the filer, the state, the IRS district (this may be determined based on the ZIP code entered) or any other similar relevant information.

In another aspect, the present invention provides that the tax preparation product can be integrated with the tax insurance provided according to the present invention so that entry of certain information by the taxpayer during the operation of the tax preparation product and before the final tax is determined, can trigger a prompt for the taxpayer to purchase tax audit insurance. Typically, this integration would be based on information entered by the taxpayer that could result in a higher risk of a tax audit. Examples of such information includes, for example, a designation that certain schedules will be filed, inputting certain deductions or when deductions exceed a certain percentage of the taxpayer income, or any other filer characteristic that is determined to trigger a higher risk, for example over a predetermined threshold, for a tax audit. Furthermore, this aspect of the invention can provide that the tax insurance premium rate may also be calculated and offered using the tax preparation inputted information so that a higher premium rate can be offered to those taxpayers having a higher risk of being audited.

In another aspect, the present invention provides tax insurance for errors relating to a tax preparation service, for example, an error in the tax preparation software and/or errors that arise from an error or misunderstanding of the tax preparation program on the part of the taxpayer. This coverage could be in addition to or in place of any standard errors and omission type insurance coverage offered by the tax preparation service that covers errors caused by the tax preparation service or the tax preparation software. This additional tax preparation errors insurance could be calculated, in part, based on error statistics from the tax preparation service obtained from their user data. This additional tax preparation errors insurance would then be added to the audit protection insurance rate previously obtained, and provided as a composite number to the user.

It should be understood that electronic network, as used in the present invention, defines a class of data communication networks to one skilled in the art and includes networks that may be implemented using, for example, optical or other means.

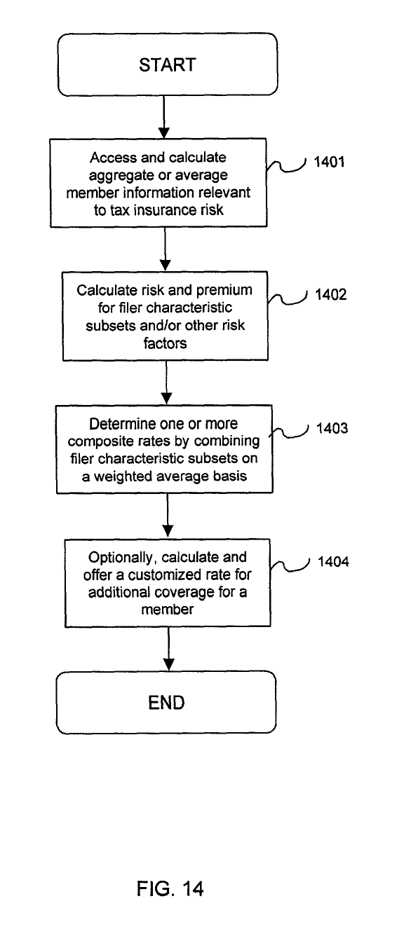

FIG. 14 is a flowchart illustrating the steps of offering the tax insurance, according to the present invention, to members of an affinity group, for example, or the employees of a company. In step 1401, aggregate or average member information useful for assessing the tax insurance risk and premiums is accessed. It should be understood that “average” member information can be a mean, median, or mode calculation based on the member information or any combination thereof or some other computed value based on the member information (for example, a weighted average value). For example, a distribution of employees in particular income group subsets can be accessed. Therefore, for example, the information accessed may included the number of employees earning (i) less than $25,000, (ii) between $25,000-50,000, (iii) between $50,000-75,000; (iv) $75,000-100,000; and (v) over $100,000. Some other tax insurance related risk factors may also be applied based on a particular company or the type of the company (for example, whether it is staffed mostly by professionals or whether most members have their own business).

In step 1402, the different filing characteristic subsets are derived based on the member information accessed so that risk and premium calculations for each filing characteristic subsets can be made. The actual risk and premium calculation for the tax audit insurance can be performed similarly to that discussed earlier herein by comparing the taxpayers information to the filing characteristic subsets derived from examination and taxpayer profile information periodically published by appropriate taxing authorities. In step 1403, a composite rate for the members of the affinity group is calculated by weighting based on the number of members in each filing characteristic subset and, optionally, one or more other relevant underwriting factors. In an alternative embodiment, more than one composite rate may be derived by combining several filing characteristic subsets into one. For example, the filing characteristic subset based on income groups (i) and (ii) (those earning less than $50,000) may be combined (weighted average) to derive one composite rate, while the filing characteristic subsets based on income groups (iii)-(v) (those earning more than $50,000) may be combined to derive a second composite rate.

In step 1404, an optional combination of a composite rate with a customized rate may be offered, for example, for those members (or employees) that seek additional tax insurance coverage. Therefore, in one embodiment, one or more composite rates may be calculated and offered for a certain tax insurance coverage level. This composite rate may then be added to a different additional rate that is calculated based on the taxpayer information of the member using, for example, the filing characteristic subsets discussed earlier to derive the customized rate, if a member desires additional coverage beyond the composite rate coverage level.

In another embodiment of the bundling of the tax audit insurance (according to the present invention) with distribution channels and related services, the present invention contemplates offering of computerized tax preparation services with tax insurance that provides interactive help or consultation services for the employee or affinity group member. The consultation services may provide interactive information on how to use the tax preparation software and guidance on relating to how to prepare an individual's taxes as well as on the need and quantity of tax audit insurance.

In another embodiment of the bundling of the tax audit insurance according to the present invention with an affinity group such as an employer, the employee benefit may include an automatic computer transfer of the employee's specific information relating to their income level, transfer of their IRS W-2 information, and assignment (or provision) of data by the employee to have an employer sponsored computer automatically prepare the tax return for the employee. This may include, for example, a data feed containing IRS 1099 information for the employee and other relevant information that may be need by the computer to automatically prepare a return for the employee to review and either file or adjust as appropriate. This employer computer based automatic preparation feature according to the present invention permits the employee or affinity group member to receive their tax return already completed for their review and either adjustment or filing.

In a further embodiment of the bundling of the tax audit insurance, the present invention provides taxpayers may be able to purchase tax audit protection insurance or an ATA membership (including audit protection insurance along with other services such as tax preparation and tax help) through a Refund Anticipation Loan (RAL) process whereby fees (or premiums) can be deducted from the RAL check,.

In another embodiment of the bundling of the tax audit insurance, the present invention provides for a computer-implemented method of offering audit and tax insurance exclusively or in combination with third-party products and services such as (1) tax preparation services and software and (2) tax-related support systems such as phone-based hotlines or online tax support such as message boards, community “chat” rooms or interactive one-on-one chat (whether automated or handled by live personnel). In a preferred embodiment, such combinations of products and services are offered to individuals, employees or affinity group members through an application service provider model, implemented either locally within an Intranet or accessible remotely through a computer network such as the Internet.

One aspect of the present invention provides a computer-implemented method of collecting parameter values for enrollment purposes, entered interactively by the taxpayer or derived automatically through transfer of required data from linked applications such as third-party registration or check-out processes, or directly from linked data sources such as an internal corporate payroll system.

Other embodiments of the invention will be apparent to those skilled in the art from a consideration of the specification and the practice of the invention disclosed herein. For example, the preferred embodiments of the present invention discusses a tax insurance program for income taxes for different types of filers in different jurisdictions. However, it is intended that the principles of the present invention can also be applied to other types of taxes and taxation jurisdictions, for example, sales taxes, payroll taxes, Internet use taxes, etc., which can also be covered by one or more tax insurance products in accordance with the principles of the present invention. Therefore, as long as tax audit related information correlated to types of filers is available for a type of tax and taxing jurisdiction (or authority), tax insurance products can be provided for such types of taxes and taxing authorities in accordance with the principles of the present invention. It is intended that all such embodiments be considered a part of the present invention.

What is claimed is:

1. A computer implemented method of providing insurance for costs resulting from an audit by a taxing authority, comprising the steps of:
accessing data relating to tax audit costs assessed by the taxing authority correlated to one or more parameters of taxpayers;
calculating average tax audit costs for one or more groups of taxpayers using the data related to the tax audit costs wherein each group is uniquely identified by at least one of the parameter for a taxpayer; and
determining a premium rate to be charged for each group of taxpayers based on the calculated average tax audit costs.

2. The computer implemented method according to claim 1, wherein data relating to tax audit costs is obtained from information published by the taxing authority.

3. The computer implemented method according to claim 1, wherein data relating to tax audit costs is stored in a database.

4. The computer implemented method according to claim 2, wherein the data relating to tax audit costs is accessed from a third party source.

5. The computer implemented method according to claim 1, further comprising:
calculating average representation costs for defending a tax audit for taxpayers in each group; and
adjusting the premium rates based on the calculated average representation costs.

6. The computer implemented method according to claim 1, wherein the step of determining the premium rate includes accessing a claims database storing information regarding prior claims.

7. The computer implemented method according to claim 1, wherein the parameters include one or more of a filing status of taxpayer, total income of taxpayer, type of tax return filed by taxpayer, and types of deductions claimed by taxpayer.

8. The computer implemented method according to claim 1, wherein the tax audit costs include additional assessed taxes, interest on the additional assessed taxes, and penalties.

9. The computer implemented method according to claim 1, wherein the premium rates are adjusted based on data in a claims database storing information regarding prior claims.

10. The computer implemented method according to claim 1, further comprising the step of displaying, in a menu for a financial or tax services program, an option to initiate the steps of claim 1.

11. The computer implemented invention according to claim 10, wherein said parameters include one or more of a taxpayer location, taxpayer income, and type of tax return.

12. The computer implemented invention according to claim 11, wherein one or more of said parameters is obtained by accessing data acquired by the financial or tax services program.

13. A computer implemented method of interactively calculating and displaying risk and premium data for costs associated with a tax audit by a taxing authority, the method comprising the steps of:
accessing tax audit statistics provided by the taxing authority;
correlating tax audit costs to one or more parameters of taxpayers;
calculating the average tax audit costs for groups of taxpayers wherein the groups of taxpayers are uniquely identified by values of the parameters; and
receiving parameter values entered interactively by a taxpayer;
determining a particular group for the taxpayer from said groups based on the parameter values entered by the taxpayer; and
displaying the average tax audit costs corresponding to that particular group based on the parameter values received from the taxpayer.

14. A computer readable data storage medium having program code recorded thereon for providing insurance for costs assessed from a tax audit by a taxing authority, the program code comprising:
a first program code that accesses data relating to tax audit costs assessed by the taxing authority correlated to one or more parameters of taxpayers;
a second program code that calculates average tax audit costs for one or more groups of taxpayers using the data related to the tax audit costs, wherein each group is uniquely identified by parameter values for a taxpayer; and
a third program code that determines a premium rate to be charged for each group of taxpayers based on the calculated average tax audit costs.

15. A system for providing insurance for the costs associated with a tax audit by a taxing authority, the system comprising:
means for accessing data relating to tax audit costs assessed by the taxing authority correlated to one or more parameters of taxpayers;
means for calculating average tax audit costs for one or more groups of taxpayers using the data related to the tax audit costs, wherein each group is uniquely identified by parameter values for a taxpayer; and
means for determining a premium rate to be charged for each group of taxpayers based on the calculated average tax audit costs.

16. A method of distributing a tax insurance product by association with a tax preparation product, comprising the steps of;
providing an option displayed by the tax preparation product to purchase the tax insurance product;
invoking the tax insurance product application to access taxpayer related information stored by the tax preparation product; and
calculating tax insurance parameters based on the accessed taxpayer related information.

17. The method according to claim 16, further comprising:
reviewing information entered interactively by a taxpayer and determining if the information represents a higher risk of triggering a tax audit than a predetermined risk value; and
displaying an option interactively to the taxpayer, prior to the calculation of a final tax by the tax preparation product, to purchase tax insurance if it is determined that the information entered by the taxpayer represents a higher risk of triggering an audit.

18. The method according to claim 16, wherein a rate for insurance coverage resulting from any errors from use of the tax preparation product, including a user error by the taxpayer, is added to the rate for the tax insurance product to obtain a composite rate.

19. The method according to claim 18, wherein the coverage for the tax preparation product is calculated, in part, using proprietary error data based on the use of its product obtained from a provider of the tax preparation product.

20. A computer implemented method of providing a tax insurance product as an association benefit, comprising the steps of;
issuing a master group tax insurance policy in a state for benefit of members of an association;
issuing membership notifications to the members indicating reimbursement limit for costs and assessments related to a tax authority audit provided from the master group tax insurance policy,
wherein a premium component per member is calculated and provided to the issuer of the master group tax insurance policy.

21. The method according to claims 20, further comprising:
calculating and offering an additional customized tax insurance premium rate to the member based on the information provided by the member.

22. The method according to claim 20, further comprising:
collecting, by a third party administration entity, of association membership dues from the members of the association; and
aggregating the premium components per member from the collection and paying the aggregated premium components to the issuer of the master group tax insurance policy.

23. The method according to claim 16, further comprising the steps of:
calculating risk associated with a taxpayer based on accessed taxpayer related information; and
offering or declining to offer the tax insurance product to the taxpayer based on whether the calculated risk associated with the taxpayer exceeds a predetermined risk value.

24. The method according to claim 20, wherein the premium component per member is calculated by:
determining member values for taxpayer information and filing characteristics to determine member distribution within groups determined based on taxpayer and filing characteristics;
calculating a risk value associated with the groups determined based on the taxpayer information and filing characteristics; and
determining a composite value for the premium component as a function of the risk associated with the groups weighted by the respective number of members within the groups.

25. A computer implemented method of providing tax preparation and tax audit protection services by an employer, comprising the steps of:
at an employer sponsored computer:
accessing payroll related information for an employee;
receiving additional tax related input data for the employee;
preparing a provisional tax return for the employee using the payroll related information and the additional tax related input data; and
receiving either a confirmation or an adjustment from the employee accessing the provisional tax return; and
automatically generating the final tax return for the employee after receiving the confirmation or processing the adjustment from the employee.

26. The computer implemented method according to claim 25, further comprising the steps of:
calculating and displaying a tax audit risk measure to the employee; and
providing tax audit insurance options for selection by the employee.
